(19) United States
(12) Patent Application Publication
(10) Pub. No.: US 2025/0112674 A1
(43) Pub. Date: Apr. 3, 2025

(54) USER EQUIPMENT CONFIRMATION OF NETWORK-INITIALIZED MULTIPLE INPUT, MULTIPLE OUTPUT (MIMO) COMMUNICATION

(71) Applicant: Apple Inc., Cupertino, CA (US)

(72) Inventors: Minghai Feng, Beijing (CN); Hao Sun, Beijing (CN); Cheng Li, Shanghai (CN); Yong Ba, Beijing (CN); Kexin Ma, San Diego, CA (US); Vijay Gadde, San Jose, CA (US); Dikshit Garg, San Jose, CA (US); Zhengbo Zhu, San Diego, CA (US); Drew Narciso Mera, San Diego, CA (US); Chenjia Wei, Shanghai (CN)

(21) Appl. No.: 18/824,491

(22) Filed: Sep. 4, 2024

Related U.S. Application Data
(60) Provisional application No. 63/586,244, filed on Sep. 28, 2023.
(60) Provisional application No. 63/586,249, filed on Sep. 28, 2023.

(51) Int. Cl. H04B 7/0426; H04L 5/00; H04W 74/0833

(52) U.S. Cl. CPC H04B 7/0426; H04L 5/0051; H04W 74/0833

(57) ABSTRACT

Systems and methods described herein may enable user equipment to confirm and/or change a multiple input, multiple output (MIMO) communication configuration selected by a network, such as to change a number of data layers used in the MIMO communication and/or to change one or more antennas used in the MIMO communication. The user equipment may confirm and/or change the MIMO communication configuration based on transmit power levels associated with the one or more antennas, a distance between power amplifiers and respective antennas, or the like, as described herein.

### CROSS-REFERENCE TO RELATED APPLICATION

This application claims the benefit of U.S. Provisional Application No. 63/586,244, filed Sep. 28, 2023, entitled “USER EQUIPMENT CONFIRMATION OF NETWORK-INITIALIZED MULTIPLE INPUT, MULTIPLE OUTPUT (MIMO) COMMUNICATION,” and U.S. Provisional Application No. 63/586,249, filed Sep. 28, 2023, entitled “USER EQUIPMENT CONFIRMATION OF NETWORK-INITIALIZED MULTIPLE INPUT. MULTIPLE OUTPUT (MIMO) COMMUNICATION.” each of which is incorporated by reference in its entirety for all purposes.

### BACKGROUND

The present disclosure relates generally to wireless communication, and more specifically to uplink (UL) multiple input, multiple output (MIMO) communications between transmitters and receivers in wireless communication devices.

In an electronic device, a transmitter and a receiver may each be coupled to one or more antennas to enable the electronic device to both transmit and receive wireless signals from a network, such as a cellular network system. The electronic device may include circuitry that enables UL MIMO communications. The electronic device and the network may perform a communication initialization process to determine a MIMO communication configuration to implement when communicating with each other. However, this communication initialization process may result in communication configurations that limit a signal power able used by the transmitter. Limiting the signal power may negatively impact communications between the electronic device and the network by potentially making the communications more vulnerable to long distance communications, environmental changes, or other transmission variables.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In one embodiment, an electronic device may include a transmitter having multiple antennas and one or more processors coupled to the transmitter. The one or more processors may receive sensing data corresponding to a transmit power level of each antenna of the antennas, may cause the transmitter to send a sounding reference signal (SRS) set via one or more antennas to a network, where the one or more antennas may be selected from the antennas based on the sensing data, and may cause the transmitter to exchange user data with the network based on transmission diversity.

In another embodiment, a non-transitory computer-readable medium may include instructions that, when executed by one or more processors, cause the one or more processors to perform operations that include sending, via a transmitter coupled to one or more antennas, a sounding reference signal (SRS) set to a network. The operations may include receiving, via a receiver coupled to the one or more antennas, an indication of a data layer transmission mode from the network. The operations may include confirming the data layer transmission mode based on a power level of the one or more antennas. The operations may include sending, via the transmitter coupled to the one or more antennas, user data to the network using the data layer transmission mode.

In yet another embodiment, a method may include receiving, via a processor, sensing data corresponding to a transmit power level of each antenna of multiple antennas. The method may include sending, via a transmitter coupled to one or more antennas, a first sounding reference signal (SRS) set to a network, the one or more antennas selected from the multiple antennas based on the sensing data. The method may include receiving, via a receiver coupled to the one or more antennas, an indication of a data layer transmission mode from the network. The method may include sending, via the transmitter coupled to the one or more antennas, user data to the network using the data layer transmission mode.

In another embodiment, a computing system may include a transceiver and one or more processors coupled to the transceiver. The one or more processors may cause the transceiver to receive a first indication from user equipment. The first indication may communicate a transmission power difference corresponding to one or more antennas of the user equipment. The one or more processors may configure uplink resources associated with the user equipment using a spatial multiplexing single layer (SMSL) mode via a first data layer based on the first indication. The one or more processors may cause the transceiver to send, via the uplink resources, a second indication of the SMSL mode and the first data layer to the user equipment.

In yet another embodiment, a user equipment device may include a transceiver having one or more antennas and one or more processors coupled to the transceiver. The one or more processors may cause the transceiver to transmit a first indication to a network, the first indication communicating a transmission power difference corresponding to the one or more antennas. The one or more processors may cause the transceiver to receive a second indication of a spatial multiplexing single layer (SMSL) mode via a first data layer from the network. The one or more processors may switch between the SMSL mode and a spatial multiplexing dual layer (SMDL) mode from the SMSL mode based on sensing data.

In another embodiment, a method may include receiving, via a transceiver, a first indication from user equipment. The first indication may communicate a transmission power difference corresponding to one or more antennas of the user equipment. The method may include configuring, via a processor, uplink resources associated with the user equipment based on a spatial multiplexing single layer (SMSL) mode via a first data layer based on the first indication. The method may include sending, via the transceiver, a second indication of the SMSL mode and the first data layer to the user equipment.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings described below in which like numerals refer to like parts.

FIG. 1 is a block diagram of an electronic device, according to embodiments of the present disclosure;

FIG. 2 is a functional diagram of the electronic device of FIG. 1, according to embodiments of the present disclosure;

FIG. 3 is a schematic diagram of a transmitter of the electronic device of FIG. 1, according to embodiments of the present disclosure;

FIG. 4 is a schematic diagram of a receiver of the electronic device of FIG. 1, according to embodiments of the present disclosure;

FIG. 5 is a schematic diagram of a communication system including the user equipment of FIG. 1 communicatively coupled to a wireless communication network supported by base stations, according to embodiments of the present disclosure;

FIG. 6 is a diagrammatic representation of a method performed to initialize multiple input, multiple output (MIMO) communications based on open loop and closed loop operations, according to embodiments of the present disclosure;

FIG. 7 is a flowchart of the method of FIG. 6 that may be performed to initialize the MIMO communications based on the user equipment of FIG. 1 sending, during the open loop operations, an indication of a maximum transmission power difference associated with one or more candidate antennas, according to embodiments of the present disclosure;

FIG. 8 is a flowchart of the method of FIG. 6 that may be performed to initialize the MIMO communications based on sounding operations associated with the closed loop operations, according to embodiments of the present disclosure;

FIG. 9 is a flowchart of a method corresponding to the sounding operations of FIG. 8 that may be performed to confirm the selected number of data layers, according to embodiments of the present disclosure;

FIG. 10 is a diagrammatic representation of the method corresponding to the sounding operations of FIGS. 8-9 used to confirm the selected number of data layers, according to embodiments of the present disclosure;

FIG. 11 is a flowchart of a method performed to switch a data layer selection based on the sounding operations of FIG. 8, where the switching is based on the user equipment of FIG. 1 muting one or more antennas as part of a repeated open loop operation, according to embodiments of the present disclosure;

FIG. 12 is a flowchart of a method performed to switch a data layer selection based on the sounding operations of FIG. 8, where the switching is based on the user equipment of FIG. 1 sending an indication of its data layer selection as part of a repeated open loop operation, according to embodiments of the present disclosure;

FIG. 13 is a flowchart of a method corresponding to the sounding operations of FIG. 8 that may be performed to confirm a channel selection associated with a single data layer selection (SMSL mode) associated with the communication initialization method of FIG. 7, according to embodiments of the present disclosure;

FIG. 14 is a diagrammatic representation of the method corresponding to the sounding operations of FIGS. 8 and 13 used to confirm the channel selection, according to embodiments of the present disclosure;

FIG. 15 is a flowchart of another example method corresponding to the sounding operations of FIG. 7 that may be performed to confirm a channel selection associated with a single data layer selection (SMSL mode) associated with the communication initialization method of FIG. 7 based on a transmission power maximum and a maximum transmit power level (MTPL) associated with one or more antennas, according to embodiments of the present disclosure;

FIG. 16 is a diagrammatic representation of the method corresponding to the sounding operations of FIGS. 8, 9, and 13 used to confirm the selected number of data layers and the channel selection, according to embodiments of the present disclosure;

FIG. 17 is a flowchart of the method of FIG. 6 that may be performed to initialize the MIMO communications based on one or more of the operations described relative to FIGS. 7-16 and applied to a specific use case of Voice-over-Cellular (e.g., Voice-over-New-Radio (NR) network), according to embodiments of the present disclosure;

FIG. 18 is a flowchart of a method that may be performed to determine a subset of antennas by which to send a sounding reference signal (SRS) based on adaptive MTPL operations, according to embodiments of the present disclosure;

FIG. 19 is a diagrammatic representation of operations of FIG. 18 corresponding to selecting the subset of antennas based on MTPL per-transmitting (TX) antenna combination (e.g., pair of antennas), according to embodiments of the present disclosure;

FIG. 20 is a flowchart of a method corresponding to the operations of FIG. 19 to select the subset of antennas based on MTPL per-TX antenna combination, according to embodiments of the present disclosure;

FIG. 21 is a diagrammatic representation of operations of FIG. 18 corresponding to selecting the subset of antennas based on MTPL per-TX antenna per-power amplifier, according to embodiments of the present disclosure;

FIG. 22 is a flowchart of a method corresponding to the operations of FIG. 21 to select the subset of antennas based on MTPL per-TX antenna combination, according to embodiments of the present disclosure;

FIG. 23 is a flowchart of the method of FIG. 6 that may be performed to initialize the MIMO communications based on confirming the selected number of data layers using MTPL considerations associated with the closed loop operations, according to embodiments of the present disclosure;

FIG. 24 is a diagrammatic representation of one or more power amplifiers (PA) and one or more antennas to illustrate an example of how PA-to-port transmission pathways may affect power of transmitting signals, and thus be an example of the MTPL considerations of FIG. 23, according to embodiments of the present disclosure;

FIG. 25 is a flowchart of a method that may be performed to confirm the selected number of data layers using the MTPL considerations of FIGS. 23-24, according to embodiments of the present disclosure;

FIG. 26 is a diagrammatic representation of the MTPL considerations of FIGS. 23-25 corresponding to spatial multiplexing dual layer (SMDL), according to embodiments of the present disclosure;

FIG. 27 is a diagrammatic representation of the MTPL considerations of FIGS. 23-25 corresponding to spatial multiplexing single layer (SMSL), according to embodiments of the present disclosure;

FIG. 28 is a diagrammatic representation of a method that may be performed by the user equipment of FIG. 1 to enable transmission diversity while in a connected mode with the network of FIG. 5 to boost power of a transmit signal, according to embodiments of the present disclosure;

FIG. 29 is a flowchart of the method of FIG. 23 that may be performed to initialize the MIMO communications based on confirming network MIMO communication selections using MTPL considerations of FIG. 28, according to embodiments of the present disclosure;

FIG. 30 is a diagrammatic representation of a method that may be performed by the user equipment of FIG. 1 to enable transmission diversity while in an idle mode with the network of FIG. 5 to boost power of a transmit Random Access Channel (RACH) signal, according to embodiments of the present disclosure; and

FIG. 31 is a flowchart of methods associated with FIG. 30 that may be applied to determining whether to transmit the RACH signal with TX diversity, according to embodiments of the present disclosure.

### DETAILED DESCRIPTION OF SPECIFIC EMBODIMENTS

When introducing elements of various embodiments of the present disclosure, the articles “a,” “an,” and “the” are intended to mean that there are one or more of the elements. The terms “comprising.” “including.” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the particular features, structures, or characteristics may be combined in any suitable manner in one or more embodiments. Use of the terms “approximately.” “near.” “about.” “close to,” and/or “substantially” should be understood to mean including close to a target (e.g., design, value, amount), such as within a margin of any suitable or contemplatable error (e.g., within 0.1% of a target, within 1% of a target, within 5% of a target, within 10% of a target, within 25% of a target, and so on). Moreover, it should be understood that any exact values, numbers, measurements, and so on, provided herein, are contemplated to include approximations (e.g., within a margin of suitable or contemplatable error) of the exact values, numbers, measurements, and so on. Additionally, the term “set” may include one or more. That is, a set may include a unitary set of one member, but the set may also include a set of multiple members.

This disclosure is directed to multiple input, multiple output (MIMO) communications. A network (e.g., cellular network system) and user equipment (e.g., electronic device) may perform a communication initialization process to determine a communication configuration. The network and the user equipment may communicate with each other based on the communication configuration. For example, the network may select (as the communication configuration) an antenna (corresponding to a communication channel) and a number of data layers to use when communicating with the user equipment. The user equipment receives an indication of the communication configuration and uses the selected communication channel, antenna, and selected number of data layers when communicating with the network. These operations may be performed by the network without consideration of transmission power from the user equipment and the effect the selected configurations may have on the transmission power. Thus, the communication initialization process may result in a communication configuration that undesirably limits (e.g., “caps”) a signal power able used by the transmitter. Limiting the signal power may negatively impact communications between the electronic device and the network by potentially making the communications more vulnerable to long distance communications, environmental changes, or other transmission variables.

Embodiments herein provide various apparatuses and techniques to determine the communication configuration for MIMO communications based on transmission power and/or other sensed data of the user equipment (UE). By doing so, the user equipment implementing the communication configuration may transmit with relatively higher signal power levels, which may improve communication quality and overall communication resiliencies to other changing variables noted above (e.g., distance, temperature, pressure, environment). To do so, the embodiments disclosed herein include the user equipment selecting a subset of its antennas by which to send a sounding reference signal (SRS) based on maximum transmit power level (MTPL) of the antennas, the user equipment confirming the number of data layers and/or channel selected by the network, the user equipment sending an indication of a maximum power difference between one or more candidate antennas to the network and the network selecting the communication channel and the number of data layers based on the indication, performing sounding operations to test and change the network selection over time via UE-transmitted indications, muting procedures, or UE-side changes, and the like. In some cases, the user equipment further considers combinations of power amplifiers and/or antennas when determining the subset of antennas by which to send the SRS based on MTPLs of the combinations of ports/antennas. SRS transmission operations may also involve an analysis of whether to send the SRS signal based on transmission (TX) diversity or not. Furthermore, confirming the number of data layers selected by the network may involve a port switching operation by which the user equipment may determine that more transmit power may be used by switching a combination of antenna/port, and power amplifier. As described further below, some or all of these operations may be applied to other communication initialization operations, such as operations associated with Random Access Channel (RACH) transmission.

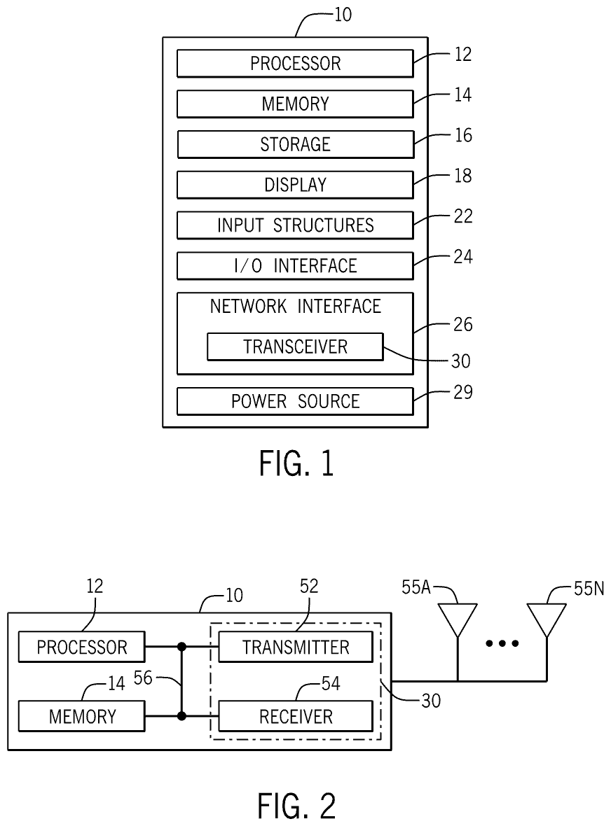

Keeping the foregoing in mind, FIG. 1 is a block diagram of an electronic device 10, according to embodiments of the present disclosure. The electronic device 10 may include, among other things, one or more processors 12 (collectively referred to herein as a single processor for convenience, which may be implemented in any suitable form of processing circuitry), memory 14, nonvolatile storage 16, a display 18, input structures 22, an input/output (I/O) interface 24, a network interface 26, and a power source 29. The various functional blocks shown in FIG. 1 may include hardware elements (including circuitry), software elements (including machine-executable instructions) or a combination of both hardware and software elements (which may be referred to as logic). The processor 12, memory 14, the nonvolatile storage 16, the display 18, the input structures 22, the input/output (I/O) interface 24, the network interface 26, and/or the power source 29 may each be communicatively coupled directly or indirectly (e.g., through or via another component, a communication bus, a network) to one another to transmit and/or receive signals between one another. It should be noted that FIG. 1 is merely one example of a particular implementation and is intended to illustrate the types of components that may be present in the electronic device 10.

By way of example, the electronic device 10 may include any suitable computing device, including a desktop or notebook computer, a portable electronic or handheld electronic device such as a wireless electronic device or smartphone, a tablet, a wearable electronic device, and other similar devices. In additional or alternative embodiments, the electronic device 10 may include an access point, such as a base station, a router (e.g., a wireless or Wi-Fi router), a hub, a switch, and so on. It should be noted that the processor 12 and other related items in FIG. 1 may be embodied wholly or in part as software, hardware, or both. Furthermore, the processor 12 and other related items in FIG. 1 may be a single contained processing module or may be incorporated wholly or partially within any of the other elements within the electronic device 10. The processor 12 may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that may perform calculations or other manipulations of information. The processors 12 may include one or more application processors, one or more baseband processors, or both, and perform the various functions described herein.

In the electronic device 10 of FIG. 1, the processor 12 may be operably coupled with a memory 14 and a nonvolatile storage 16 to perform various algorithms. Such programs or instructions executed by the processor 12 may be stored in any suitable article of manufacture that includes one or more tangible, computer-readable media. The tangible, computer-readable media may include the memory 14 and/or the nonvolatile storage 16, individually or collectively, to store the instructions or routines. The memory 14 and the nonvolatile storage 16 may include any suitable articles of manufacture for storing data and executable instructions, such as random-access memory, read-only memory, rewritable flash memory, hard drives, and optical discs. In addition, programs (e.g., an operating system) encoded on such a computer program product may also include instructions that may be executed by the processor 12 to enable the electronic device 10 to provide various functionalities.

In certain embodiments, the display 18 may facilitate users to view images generated on the electronic device 10. In some embodiments, the display 18 may include a touch screen, which may facilitate user interaction with a user interface of the electronic device 10. Furthermore, it should be appreciated that, in some embodiments, the display 18 may include one or more liquid crystal displays (LCDs), light-emitting diode (LED) displays, organic light-emitting diode (OLED) displays, active-matrix organic light-emitting diode (AMOLED) displays, or some combination of these and/or other display technologies.

The input structures 22 of the electronic device 10 may enable a user to interact with the electronic device 10 (e.g., pressing a button to increase or decrease a volume level). The I/O interface 24 may enable electronic device 10 to interface with various other electronic devices, as may the network interface 26. In some embodiments, the I/O interface 24 may include an I/O port for a hardwired connection for charging and/or content manipulation using a standard connector and protocol, such as the Lightning connector, a universal serial bus (USB), or other similar connector and protocol. The network interface 26 may include, for example, one or more interfaces for a personal area network (PAN), such as an ultra-wideband (UWB) or a BLUETOOTH® network, a local area network (LAN) or wireless local area network (WLAN), such as a network employing one of the IEEE 802.11x family of protocols (e.g., WI-FI®), and/or a wide area network (WAN), such as any standards related to the Third Generation Partnership Project (3GPP), including, for example, a 3rd generation (3G) cellular network, universal mobile telecommunication system (UMTS), 4th generation (4G) cellular network, Long Term Evolution® (LTE) cellular network, Long Term Evolution License Assisted Access (LTE-LAA) cellular network, 5th generation (5G) cellular network, and/or New Radio (NR) cellular network, a 6th generation (6G) or greater than 6G cellular network, a satellite network, a non-terrestrial network, and so on. In particular, the network interface 26 may include, for example, one or more interfaces for using a cellular communication standard of the 5G specifications that include the millimeter wave (mmWave) frequency range (e.g., 24.25-300 gigahertz (GHz)) that defines and/or enables frequency ranges used for wireless communication. The network interface 26 of the electronic device 10 may allow communication over the aforementioned networks (e.g., 5G, Wi-Fi, LTE-LAA, and so forth).

The network interface 26 may also include one or more interfaces for, for example, broadband fixed wireless access networks (e.g., WIMAX®), mobile broadband Wireless networks (mobile WIMAX®), asynchronous digital subscriber lines (e.g., ADSL, VDSL), digital video broadcasting-terrestrial (DVB-T®) network and its extension DVB Handheld (DVB-H®) network, ultra-wideband (UWB) network, alternating current (AC) power lines, and so forth.

As illustrated, the network interface 26 may include a transceiver 30. In some embodiments, all or portions of the transceiver 30 may be disposed within the processor 12. The transceiver 30 may support transmission and receipt of various wireless signals via one or more antennas, and thus may include a transmitter and a receiver. The processor 12 and/or the transceiver 30 may determine a communication configuration for MIMO communications based on transmission power and/or other sensed data of the electronic device 10 (e.g., user equipment (UE)). By doing so, the transceiver 30 may transmit with relatively higher signal power levels, which may improve communication quality and overall communication resiliencies to other changing variables noted above (e.g., distance, temperature, pressure, environment). To do so, the processor 12 and/or the transceiver 30 may select a subset of its antennas by which to send a sounding reference signal (SRS) based on maximum transmit power level (MTPL) of the antennas, the processor 12 and/or the transceiver 30 confirming the number of data layers and/or channel selected by the network, the processor 12 and/or the transceiver 30 sending an indication of a maximum power difference between one or more candidate antennas to the network and the network selecting the communication channel and the number of data layers based on the indication, performing sounding operations to test and change the network selection over time via UE-transmitted indications, muting procedures, or UE-side changes, and the like. In some cases, the processor 12 and/or the transceiver 30 further considers combinations of power amplifiers and/or antennas when determining the subset of antennas by which to send the SRS based on MTPLs of the combinations of ports/antennas. SRS transmission operations may also involve an analysis of whether to send the SRS signal based on transmission (TX) diversity or not. Furthermore, confirming the number of data layers selected by the network may involve a port switching operation by which the processor 12 and/or the transceiver 30 may determine that more transmit power may be used by switching a combination of antenna/port, and power amplifier. As described further below, some or all of these operations may be applied to other communication initialization operations, such as operations associated with Random Access Channel (RACH) transmission.

The power source 29 of the electronic device 10 may include any suitable source of power, such as a rechargeable lithium polymer (Li-poly) battery and/or an alternating current (AC) power converter.

FIG. 2 is a functional diagram of the electronic device 10 of FIG. 1, according to embodiments of the present disclosure. As illustrated, the processor 12, the memory 14, the transceiver 30, a transmitter 52, a receiver 54, and/or antennas 55 (illustrated as 55A-55N, collectively referred to as an antenna 55) may be communicatively coupled directly or indirectly (e.g., through or via another component, a communication bus, a network) to one another to transmit and/or receive signals between one another.

The electronic device 10 may include the transmitter 52 and/or the receiver 54 that respectively enable transmission and reception of signals between the electronic device 10 and an external device via, for example, a network (e.g., including base stations or access points) or a direct connection. As illustrated, the transmitter 52 and the receiver 54 may be combined into the transceiver 30. The electronic device 10 may also have one or more antennas 55A-55N electrically coupled to the transceiver 30. The antennas 55A-55N may be configured in an omnidirectional or directional configuration, in a single-beam, dual-beam, or multi-beam arrangement, and so on. Each antenna 55 may be associated with one or more beams and various configurations. In some embodiments, multiple antennas of the antennas 55A-55N of an antenna group or module may be communicatively coupled to a respective transceiver 30 and each emit radio frequency signals that may constructively and/or destructively combine to form a beam. The electronic device 10 may include multiple transmitters, multiple receivers, multiple transceivers, and/or multiple antennas as suitable for various communication standards. In some embodiments, the transmitter 52 and the receiver 54 may transmit and receive information via other wired or wireline systems or means.

As illustrated, the various components of the electronic device 10 may be coupled together by a bus system 56. The bus system 56 may include a data bus, for example, as well as a power bus, a control signal bus, and a status signal bus, in addition to the data bus. The components of the electronic device 10 may be coupled together or accept or provide inputs to each other using some other mechanism.

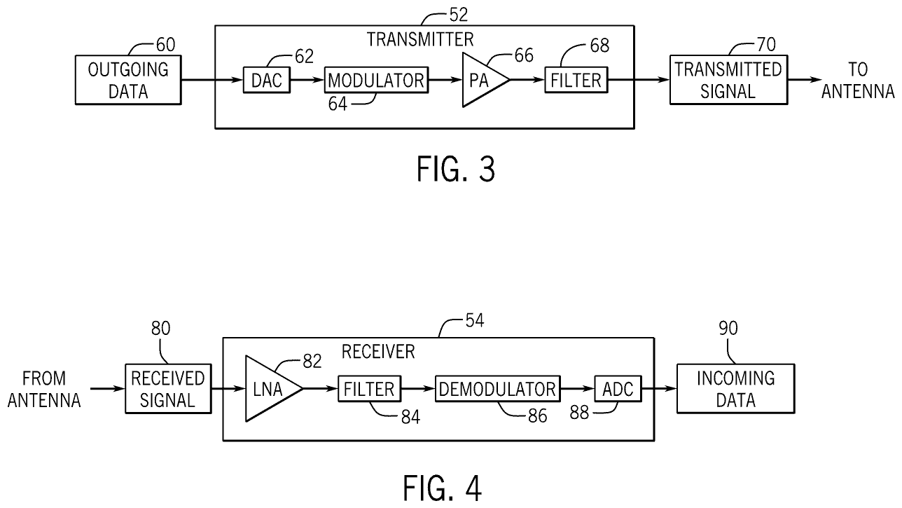

FIG. 3 is a schematic diagram of the transmitter 52 (e.g., transmit circuitry), according to embodiments of the present disclosure. As illustrated, the transmitter 52 may receive outgoing data 60 in the form of a digital signal to be transmitted via the one or more antennas 55. A digital-to-analog converter (DAC) 62 of the transmitter 52 may convert the digital signal to an analog signal, and a modulator 64 may combine the converted analog signal with a carrier signal to generate a radio wave. A power amplifier 66 (PA) receives the modulated signal from the modulator 64. The power amplifier 66 may amplify the modulated signal to a suitable level to drive transmission of the signal via the one or more antennas 55. A filter 68 (e.g., filter circuitry and/or software) of the transmitter 52 may then remove undesirable noise from the amplified signal to generate transmitted signal 70 to be transmitted via the one or more antennas 55. The filter 68 may include any suitable filter or filters to remove the undesirable noise from the amplified signal, such as a bandpass filter, a bandstop filter, a low pass filter, a high pass filter, and/or a decimation filter.

The power amplifier 66 and/or the filter 68 may be referred to as part of a radio frequency front end (RFFE), and more specifically, a transmit front end (TXFE) of the electronic device 10. Additionally, the transmitter 52 may include any suitable additional components not shown, or may not include certain of the illustrated components, such that the transmitter 52 may transmit the outgoing data 60 via the one or more antennas 55. For example, the transmitter 52 may include a mixer and/or a digital up converter. As another example, the transmitter 52 may not include the filter 68 if the power amplifier 66 outputs the amplified signal in or approximately in a desired frequency range (such that filtering of the amplified signal may be unnecessary).

FIG. 4 is a schematic diagram of the receiver 54 (e.g., receive circuitry), according to embodiments of the present disclosure. As illustrated, the receiver 54 may receive received signal 80 from the one or more antennas 55 in the form of an analog signal. A low noise amplifier 82 (LNA) may amplify the received analog signal to a suitable level for the receiver 54 to process. A filter 84 (e.g., filter circuitry and/or software) may remove undesired noise from the received signal, such as cross-channel interference. The filter 84 may also remove additional signals received by the one or more antennas 55 that are at frequencies other than the desired signal. The filter 84 may include any suitable filter or filters to remove the undesired noise or signals from the received signal, such as a bandpass filter, a bandstop filter, a low pass filter, a high pass filter, and/or a decimation filter. The low noise amplifier 82 and/or the filter 84 may be referred to as part of the RFFE, and more specifically, a receiver front end (RXFE) of the electronic device 10.

A demodulator 86 may remove a radio frequency carrier signal and/or extract a demodulated signal (e.g., an envelope signal) from the filtered signal for processing. An analog-to-digital converter (ADC) 88 may receive the demodulated analog signal and convert the signal to a digital signal of incoming data 90 to be further processed by the electronic device 10. Additionally, the receiver 54 may include any suitable additional components not shown, or may not include certain of the illustrated components, such that the receiver 54 may receive the received signal 80 via the one or more antennas 55. For example, the receiver 54 may include a mixer and/or a digital down converter.

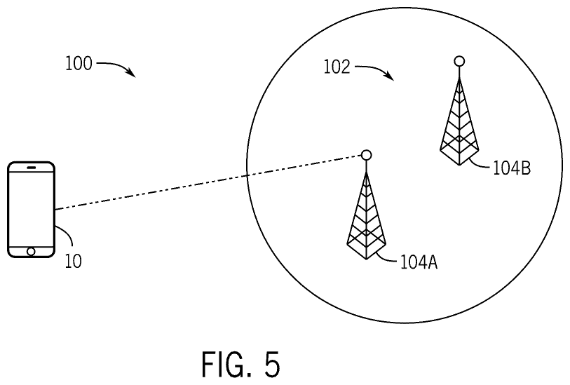

FIG. 5 is a schematic diagram of a communication system 100 including the electronic device 10 of FIG. 1 (e.g., user equipment) communicatively coupled to a wireless communication network 102 supported by base stations 104A, 104B (collectively 104), according to embodiments of the present disclosure. In particular, the base stations 104 may include Next Generation NodeB (gNodeB or gNB) base stations and may provide 5G/NR coverage via the wireless communication network 102 to the electronic device 10. The base stations 104 may include any suitable electronic device, such as a communication hub or node, that facilitates, supports, and/or implements the network 102. In some embodiments, the base stations 104 may include Evolved NodeB (eNodeB) base stations and may provide 4G/LTE coverage via the wireless communication network 102 to the electronic device 10. Each of the base stations 104 may include at least some of the components of the electronic device 10 shown in FIGS. 1 and 2, including one or more processors 12, the memory 14, the storage 16, the transceiver 30, the transmitter 52, the receiver 54, and the associated circuitry shown in FIGS. 3 and 4. It should be understood that while the present disclosure may use 5G/NR as an example specification or standard, the embodiments disclosed herein may apply to other suitable specifications or standards (e.g., such as the 4G/LTE specification, a sub-4G specification, a beyond 5G specification, such as a 6G specification, and so on). Moreover, the network 102 may include any suitable number of base stations 104 (e.g., one or more base stations 104, four or more base stations 104, ten or more base stations 104, and so on).

For ease of reference herein, processor(s) corresponding to the base stations 104 may be referred to as processors 12B and processor(s) corresponding to the electronic device 10 may be referred to as processors 12A. Processors 12 may execute instructions stored in memories 14 that cause the base stations 104 and/or the electronic device 10 to perform operations, as described herein.

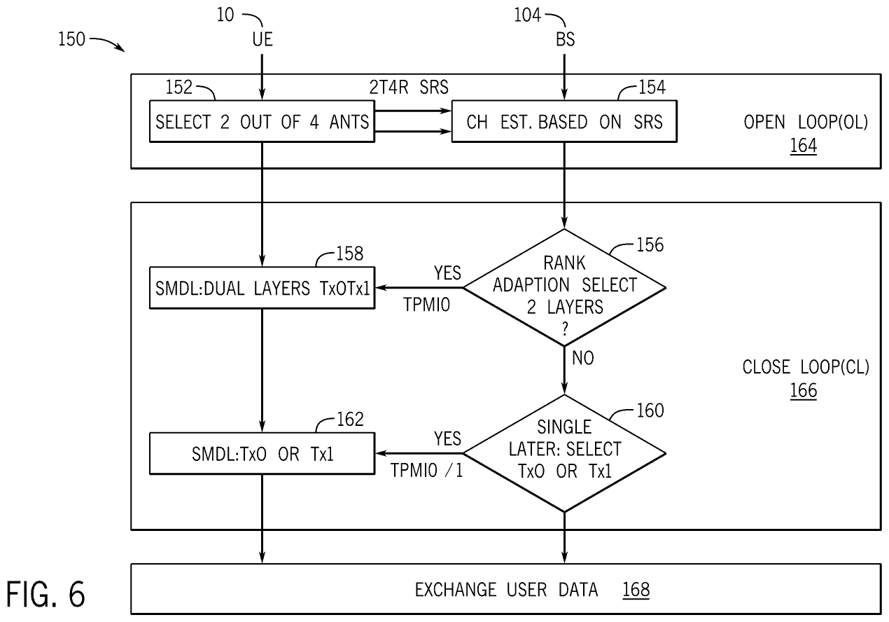

FIG. 6 is a diagrammatic representation of a method 150 performed to initialize multiple input, multiple output (MIMO) communications based on open loop operations 164 and closed loop operations 166, according to embodiments of the present disclosure. Some of the method 150 may be performed by electronic device 10 via processors 12A and some of the method 150 may be performed by electronic devices associated with the network 102, such as the base station 104 via a processor 12B. To connect to the network, the electronic device 10 may send a sounding reference signal (SRS) via one or more antennas. Based on the SRS, the network 102 designs a communication configuration and transmits an indication of the communication configuration to the user equipment for implementation. The communication channel selection and number of data layer selections may be examples of data to be included as part of a communication configuration when being designed for MIMO communications. The channel selection may indicate a communication channel established between the electronic device 10 and the base station 104 to exchange user data. Thus, an indication of the channel selection may indicate, to the electronic device 10, which of its antennas 55 the base station 104 has selected for SRS communication.

To elaborate, at process block 152, the electronic device 10 selects the one or more antennas to send the SRS. The electronic device 10 selects the one or more antennas 55 from multiple antennas based on signaling strength of the four antennas 55 (e.g., greatest signal strength of the antenna options), the MTPL per-port (e.g., greatest MTPL of the port options), signal quality, directionality, or the like. For example, the electronic device 10 may select two antennas 55 out of four antennas 55.

At block 154, the base station 104 receives the SRS and estimates a communication channel based on the SRS. The base station 104 may determine the communication channel based on the SRS and/or the relative strength of the SRS.

At block 156, the base station 104 performs a rank adaption to determine whether to select a number of data layers as two layers (e.g., multiple data layers) or whether to select one layer based on the SRS and/or network-side implementation parameters. A two data layer transmission (e.g., two antennas, Tx0Tx1, and two data layers) may correspond to a spatial multiplexing dual layer (SMDL) transmission mode. A one data layer transmission (e.g., one antenna, Tx0 or Tx1, and one data layer) may correspond to a spatial multiplexing single layer (SMSL) transmission mode.

A data layer may be a number of data streams being transmitted. Thus, the data layer may be thought of a dimension that defines a geometry of data transmission. There may be two antennas 55 transmitting via two layers, one antenna 55 transmitting via one layer, two antennas 55 transmitted via one layer in MIMO communications. As used herein, Tx1 and Tx0 may refer to a respective data layers able to selected for use in MIMO communication operations. For UL MIMO operations, the SMDL mode may correspond to two antennas 55 being used to transmit via dual layers (e.g., Tx0Tx1) and the SMSL mode may correspond to one antenna 55 being used to transmit via a single layer (e.g., Tx0 or Tx1). For DL MIMO operations, the SMDL mode and the SMSL mode may not correspond 1:1 with transmit antennas. However, descriptions made herein may be made with reference to UL MIMO operations, and thus references to first data layer Tx0 and second data layer Tx1 may be made interchangeably with a first antenna 55 and a second antenna 55, a first power amplifier 66 and a second power amplifier 66, a first RF chain and a second RF chain, a first port and a second port, or the like, since the first data layer Tx0 corresponds to the first antenna 55, first power amplifier 66, first RF chain, first data or communication channel and/or first port when dealing with UL MIMO operations and since the second data layer Tx1 corresponds to the second antenna 55, second power amplifier 66, second RF chain, second data or communication channel, and/or second port when dealing with UL MIMO operations.

At block 156, in response to selecting the SMDL mode, the base station 104 transmits an indication of the SMDL mode selection as part of a transmit precoding matrix index (TPMI) (e.g., TPMI0) to the electronic device 10, which receives the indication at block 158. The indication may be transmitted as part of a communication configuration sent to the user equipment. Based on the indication, the electronic device 10 prepares its circuitry (e.g., circuitry of FIG. 3 and/or FIG. 4) to prepare for SMDL communications according to the communication configuration received from the base station 104. For example, the electronic device 10 prepares a data layer 0 (Tx0) (corresponding to a first antenna) and a transmit data layer 1 (Tx1) (corresponding to a second antenna) based on the indication of the SMDL mode to implement the communication configuration received from the base station 104.

Alternatively, at block 160, in response to selecting the SMSL mode, the base station 104 transmits an indication of the SMSL mode selection and an indication of a selected data layer (e.g., Tx0 or Tx1) to the electronic device 10, which receives the indication at block 162. The indication may be transmitted as part of a communication configuration sent to the user equipment. The indication of the SMSL mode selection may be transmitted as part of a transmit precoding matrix index (TPMI) (e.g., TPMI0/1). The base station 104 may assign the first data layer Tx0 or the second data layer Tx1 to the electronic device 10 based on relative signal strength between the data layers identifiable based on the SRS. The indication of the selected data layer corresponds to which antenna was selected, for example, whether the first antenna corresponding to Tx0 or the second antenna corresponding to Tx1 is selected was selected. Based on these indications, the electronic device 10 prepares its circuitry (e.g., circuitry of FIG. 3 and/or FIG. 4) to prepare for SMSL communications according to the communication configuration received from the base station 104. For example, the electronic device 10 may communicatively couple either the transmit communication channel 0 (Tx0) or the transmit communication channel 1 (Tx1) to a power amplifier 66 to prepare for communicating with the base station 104.

At either block 156 or block 160, the base station 104 may be generally described as including an indication of its selection of SMDL mode or SMSL mode as part of an indication of a communication configuration (CC). The communication configuration which may include other information like a paging cycle to be used with the first data layer, a paging cycle to be used with the second data layer, a time cycle to be used with the first data layer, a time cycle to be used with the second data layer, a center frequency indication to be used with the first data layer and/or the second data layer, a preference among respective data layers (Tx0 or Tx1), an indication of whether network 102 and/or base station 104 uses voice-over-New Radio (VoNR) protocol, which of the SMDL mode or SMSL mode is a dominant mode, or the like. An indication of the time cycle for a particular data layer may indicate an interval at which to send next data via that data layer, which may help reduce bottlenecking on that data layer and/or improve communications between the electronic device 10 and/or the base station 104. The information included in the communication configuration (CC) may be tailored to the selection of the SMDL mode or the SMSL mode (and any additional decisions on communication channel or other configuration parameters). For example, if the base station 104 selected SMSL mode and communication channel corresponding to the first data layer Tx0, the base station 104 may omit some information related to the communication channel corresponding to the second data layer Tx1, which may help conserve power and/or computing resources consumed by the base station 104 and/or the network 102 in preparing and/or communicating the information to the electronic device 10 (e.g., user equipment).

Preparing one or more communication channels (e.g., Tx0 and/or Tx1) for communications may include communicatively coupling the first antenna 55 to a first power amplifier 66, the second antenna 55 to a second power amplifier 66, or both. Preparatory operations may sometimes include tuning one or more antennas 55 or other circuitry to one or more frequency ranges indicated by the communication configuration, storing indications of paging cycles or any of the other parameters into memory 14 for future reference by radio frequency control circuitry, or the like.

At block 168, the electronic device 10 and the base station 104 exchange user data via the network 102. The communication configuration selected by the base station 104 is implemented at the electronic device 10 to enable the electronic device 10 to align its operations to those being performed on the network-side to communicate.

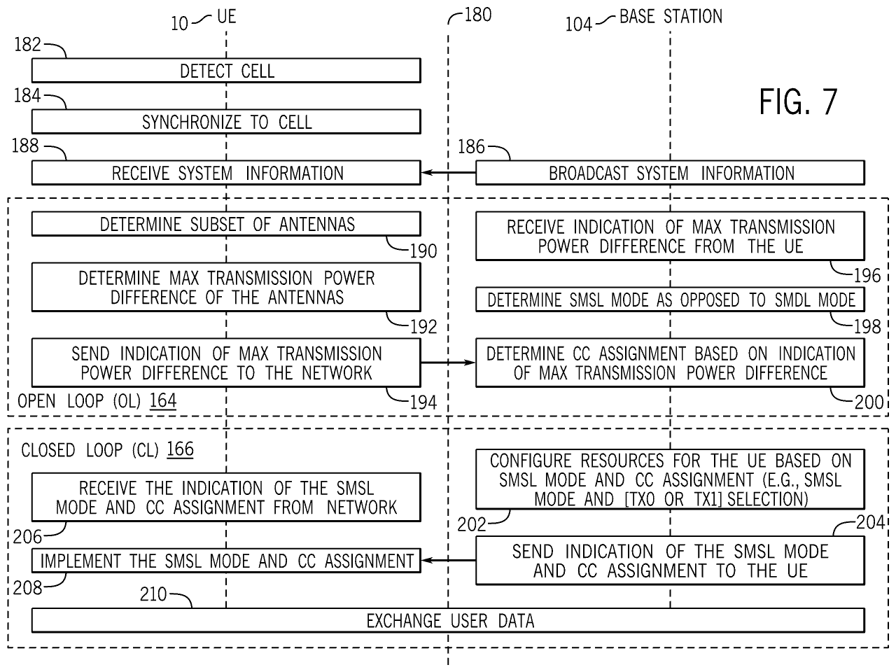

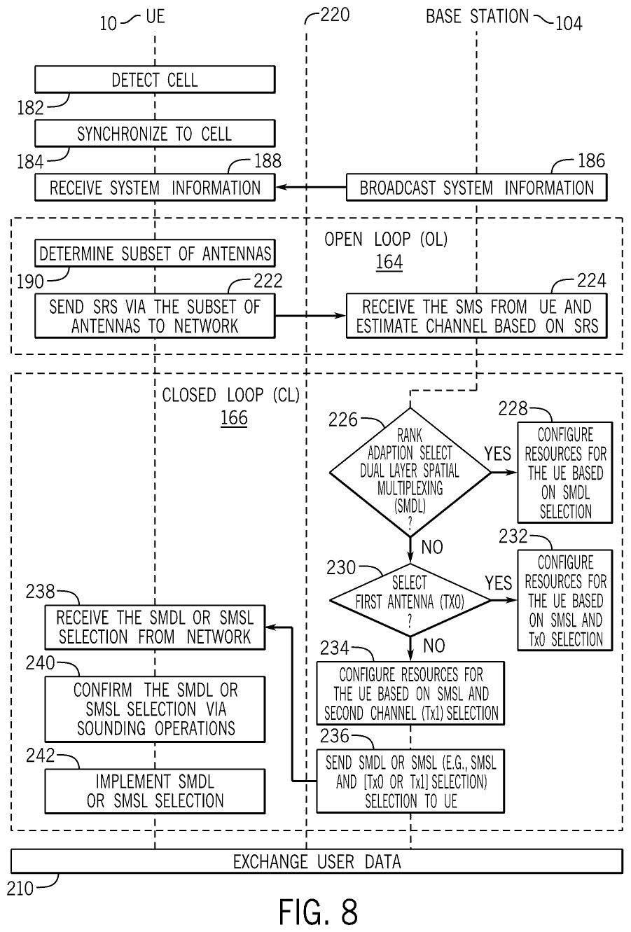

Open loop operations 164 correspond to electronic device 10 operations. Closed loop operations 166 correspond to base station 104 operations. Closed loop network control (e.g., Closed loop operations 166) may sometimes suffer from rank selection error based on power mismatches that result from selecting SMSL instead of SMDL when the electronic device 10 is better suited for SMDL, or vice versa, SRS estimation error, or the like. Closed loop network control may further experience channel selection errors based on the base station 104 selecting an undesirable channel leading to per-port power mismatches, or the like, depending on what is suitable for the electronic device 10. Furthermore, SMDL may consume additional power for some voice-over-network (e.g., VoNR) services performed by the user equipment. Thus, although communication is enabled via the method 150, power of transmit signals from the electronic device 10 may not be considered. Indeed, the electronic device 10 may communicate data using signals with lower transmit power than is possible. Examples described herein may adjust the method 150 and systems to consider user equipment transmit power and/or other parameters. For example, operations of FIG. 7 cause the electronic device 10 to transmit an indication of max transmit power difference to the base station 104 and operations of FIG. 8 involve sounding operations that let the electronic device 10 confirm the communication configuration selected by the base station 104. As may be appreciated relative to operations described between one or more of FIGS. 7-32, the electronic device 10 may adjust an antenna 55 assigned to a communication channel in its RF circuitry of FIGS. 3-4 without notifying the base station 104 of the change. In some systems, as may be appreciated relative to operations described between one or more of FIGS. 7-32, the electronic device 10 may changing a communication channel, and thus its antenna 55, which may be communicated to the base station 104 to implement the change when involving more adjustments in addition to switching antennas 55.

To elaborate, FIG. 7 is a flowchart of a method 180 corresponding to the method 150 of FIG. 6 that may be performed to initialize the MIMO communications based on the electronic device 10 (UE) sending, during the open loop operations 164, an indication of a maximum transmission power difference associated with one or more candidate antennas, according to embodiments of the present disclosure. Thus, the method 180 may correspond to a UE-assisted SMSL/TX antenna selection for UL MIMO communications that is based on both UE-side and network-side decisions and a UE-assisted antenna selection method as opposed to being a network-implemented control scheme (e.g., methods generally of FIG. 6). Any suitable device (e.g., a controller) that may control components of the electronic devices, such as the processor 12A, may perform some of the method 180. Some of the method 180 may be performed by electronic device 10 via processors 12A and some of the method 180 may be performed by electronic devices associated with the network 102, such as the base station 104 via a processor 12B. In some embodiments, the method 180 may be implemented by executing instructions stored in a tangible, non-transitory, computer-readable medium, such as the memory 14 or storage 16, using the processor 12A. For example, the method 180 may be performed at least in part by one or more software components, such as an operating system of the electronic device 10, one or more software applications of the electronic device 10, and the like. While the method 180 is described using steps in a specific sequence, it should be understood that the present disclosure contemplates that the described steps may be performed in different sequences than the sequence illustrated, and certain described steps may be skipped or not performed altogether.

Open loop operations 164 correspond to base station 104 operations of process blocks 196, 198, and 200 based on electronic device 10 operations of process blocks 190, 192, and 194. Closed loop operations 166 correspond to base station 104 operations of process blocks 202, 204 that cause electronic device 10 operations of process blocks 206 and 208. Operations of method 180 enable communication at process block 210 using relatively greater power transmit signals based on the UE-assisted network 102 selection operations, as is described here and associated with process blocks 190, 192, 194, 196, 198, 200, 202, 204, 206, and 208.

To elaborate, at process block 182, the electronic device 10 detects the base station 104 (e.g., a cell of the base station 104). In particular, the electronic device 10 may detect the base station 104 by receiving a radio frequency (RF) signal when the electronic device 10 enters a coverage area of the base station 104 (e.g., a geographical region for which the base station 104 provides network 102 coverage). The RF signal may include timing alignment information, among other information. At process block 184, the electronic device 10 synchronizes to the base station 104 (e.g., the cell of base station 104) by aligning its timing with the timing alignment information of the base station 104.

At process block 186, the base station 104 broadcasts or transmits system information indicative of frequency bands supported by the base station 104. At process block 188, the electronic device 10 reads the system information, including the indications of the frequency bands, received from the base station 104. The system information may additionally include timing specification, power specifications, Global Positioning System (GPS) or Global Navigation Satellite System (GNSS) coordinates, and/or any other suitable information to enable the electronic device 10 to establish communication with the base station 104. In some embodiments, the electronic device 10 may store the system information in the memory 14 for future usage.

At process block 190, the electronic device 10 determines a subset of antennas 55 (e.g., one or more antennas 55) to be used to transmit the SRS. The selected subset of antennas 55 may correspond to inactive antennas 55 and/or antennas deemed more proximate to the base station 104, or other selection criteria may be used.

At process block 194, the electronic device 10 determines a maximum transmission power difference of antennas 55 from the subset of antennas 55. To determine the maximum transmission power difference of the antennas 55, the electronic device 10 may use test data to evaluate the maximum transmission power of a respective antenna 55. Based on the set of data, the electronic device 10 may determine differences in power between pairs of the respective antennas 55.

At process block 196, the electronic device 10 sends an indication of the maximum transmission power difference of antennas 55 of the subset of antennas 55 to the base station 104. Various methods may be used to communicate the indication to the base station 104.

In one method, the electronic device 10 may reflect the maximum transmission power difference of antennas 55 via using a different relative amount of power to send the SRS from one or more antennas 55 (e.g., the subset of antennas 55). The SRS sent may include one or more signals, and thus may be referred to as an SRS set or an SRS combination. In this way, the electronic device 10 may various one or more signal characteristics of respective signals of the one or more signals to indicate the maximum transmission power difference between one or more of the antennas 55. For example, the SRS may include one or more component signals sent from the one or more antennas 55 of the electronic device 10, where each respective component signal of the SRS may be characterized by a different signal power corresponding to the transmission power difference, and thus communicates the indication of the maximum transmission power difference to the network 102. The electronic device 10 may indicate the transmission power difference through transmit power and/or UL received signal strength, where the UL received signal strength may be a signal strength detected by the base station 104 at reception of a respective component signal of the SRS, and where the transmit power may be an amount of power used to transmit a respective component signal of the SRS to the base station 104. If a physical uplink channel (PUSCH) transmit power corresponds to a maximum power level that is lower than the maximum transmission power difference, the electronic device 10 may use power levels to transmit the SRS from the one or more antennas 55 that is less than the maximum power level of the PUSCH and that reflects through relative differences between the respective signal power levels the maximum transmission power difference of antennas 55. In other words, both a first maximum transmission power value of a first antenna 55 may be “X” greater than a second maximum transmission power value of a second antenna 55, where both the first and second maximum transmission power values are greater than the maximum power level of the PUSCH. In this case, the electronic device 10 may reduce a power level used to transmit the SRS from the first antenna 55 and the second antenna 55 such that the SRS transmitted from the first and second antennas 55 is less than the maximum power level of the PUSCH and maintains the difference of “X” between the power levels. In some cases, a single antenna 55 is used to transmit the SRS and thus the power level of the transmitted SRS may indicate maximum transmission power difference of the antennas 55.

In another method, the electronic device 10 may transmit an indication to the base station 104 that identifies a per-port maximum transmission power difference to the base station 104. The indication transmitted may be an extent type 3 SRS power headroom report (PHR), such as a respective PHR for a respective SRS with a different resource identifier. The indication transmitted may be a new indication that identifies a per-port maximum transmission power difference transmitted to the base station 104, such as a user equipment 10 assistance information (UAI) signaling. In some cases, the electronic device 10 uses otherwise unused signaling to indicate to the base station 104 the per-port maximum transmission power difference.

At process block 196, the base station 104 receives the indication of the maximum transmission power difference from the electronic device 10. If the first method is used, the base station 104 may receive the SRS and determine what the maximum transmission power difference communicated from the electronic device 10 is based on the signal power level associated with the SRS. At process block 198, the base station 104 determines to use the SMSL mode as opposed to the SMDL mode based on the indication of the maximum transmission power difference. At process block 200, the base station 104 determines a communication configuration (CC) assignment to be used with SMSL mode based on the indication of the maximum transmission power difference. The CC assignment selects between a first data layer (Tx0) and a second data layer (Tx1) of the electronic device 10.

At block 202, the base station 104 programs resources corresponding to the electronic device 10 based on the SMSL mode and the CC assignment. The resources may enable data to be exchanged with the electronic device 10 using a single data layer transmitted via the selected communication channel (e.g., Tx0 or Tx1). Resources programmed may include uplink (UL) and/or downlink (DL) resources.

At block 204, the electronic device 10 receives the indication of the SMSL mode and the CC assignment from the base station 104. At block 208, the electronic device 10 programs one or more components of FIGS. 3-4 based on the indication of the SMSL mode and the CC assignment. For example, the first communication channel may correspond to a first antenna 55 and the second communication channel may correspond to a second antenna 55. The electronic device 10 programs circuitry to enable communications via the first antenna 55 when the first communication channel is indicated via the CC assignment. However, when the second communication channel is indicated, the electronic device 10 programs circuitry to enable communications via the second antenna 55. Other settings and/or components may be programmed in response to the indication of the SMSL mode and the CC assignment. At process block 210, the electronic device 10 and the base station 104 exchange user data and thus begin network 102 communications.

In some cases, the electronic device 10 confirms the selections of the base station 104 as opposed to determining and sending the indication of the maximum transmission power difference at blocks 192-194. To elaborate, FIG. 8 is a flowchart of a method 220 corresponding to the method 150 of FIG. 6 that may be performed to initialize the MIMO communications based on the electronic device 10 performing sounding operations associated with the closed loop operations 166 to confirm the selections from the base station 104, according to embodiments of the present disclosure. Thus, the method 220 may correspond to a UE-assisted SMSL/TX antenna selection for UL MIMO communications that is based on a UE-side sounding procedure (e.g., operations) that estimate which antenna 55 is the best one. Any suitable device (e.g., a controller) that may control components of the electronic devices, such as the processor 12A, may perform some of the method 220. Some of the method 220 may be performed by electronic device 10 via processors 12A and some of the method 220 may be performed by electronic devices associated with the network 102, such as the base station 104 via a processor 12B. In some embodiments, the method 220 may be implemented by executing instructions stored in a tangible, non-transitory, computer-readable medium, such as the memory 14 or storage 16, using the processor 12A. For example, the method 220 may be performed at least in part by one or more software components, such as an operating system of the electronic device 10, one or more software applications of the electronic device 10, and the like. While the method 220 is described using steps in a specific sequence, it should be understood that the present disclosure contemplates that the described steps may be performed in different sequences than the sequence illustrated, and certain described steps may be skipped or not performed altogether.

Open loop operations 164 correspond to base station 104 operations of process block 224 based on electronic device 10 operations of process blocks 190 and 222. Closed loop operations 166 correspond to base station 104 operations of process blocks 226, 228, 230, 232, 234, and/or 236 that cause electronic device 10 operations of process blocks 238, 240, 242. Operations of method 220 enable communication at process block 210 using relatively greater power transmit signals based on the UE-assisted network 102 selection operations.

To elaborate, at process block 182, the electronic device 10 detects the cell. At process block 184, the electronic device 10 synchronizes to the cell. At process block 188, the electronic device 10 receives the system information from the base station 104, which broadcasts the system information at process block 186. At process block 190, the electronic device 10 determines a subset of antennas 55. These operations generally correspond to operations of block 182-190 of FIG. 7 and thus descriptions are relied upon herein.

At process block 222, the electronic device 10 sends an SRS via the subset of antennas 55 to the base station 104. At process block 224, the base station 104 receives the SRS from the electronic device 10 and estimates a channel based on the SRS. At process block 226, the base station 104 determines whether to select SMDL mode based on the channel and/or the power level of the SRS. Other parameters may be considered when determining to select the SMDL mode, such as network 102 configurations, a current load, electronic device 10 capabilities, or the like. These operations correspond to operations of block 256 of FIG. 6 and these descriptions may be relied upon herein.

At process block 228, in response to the base station 104 selecting the SMDL mode for the MIMO communications, the base station 104 programs resources (e.g., uplink (UL) resources) for the electronic device 10 based on the SMDL selection and/or the estimated channel. This configuration may enable RF communication circuitry of the base station 104 to prepare to communicate with the electronic device 10. However, at process block 230, in response to the base station 104 selecting the SMSL mode for the MIMO communications at process block 226, the base station 104 may determine whether to select the first channel (Tx0) for the MIMO communications. When the base station 104 selects the first antenna 55, at process block 232, the base station 104 configures resources (e.g., uplink (UL) resources) for the electronic device 10 based on the SMSL selection, the first channel (Tx0) selection, and/or the estimated channel. However, at process block 234, in response to the base station 104 selecting the second chancel (Tx1) for the MIMO communications, the base station 104 configures the resources (e.g., uplink (UL) resources) for the electronic device 10 based on the SMSL selection, the second channel (Tx1) selection, and/or the estimated channel.

At process block 236, the base station 104 may use the programmed resources and/or associated RF circuitry (programmed based on the selections of process block 226 and/or process block 230) to send an indication of the various selections to the electronic device 10. At process block 238, the electronic device 10 may receive the indication of the selections from the base station 104.

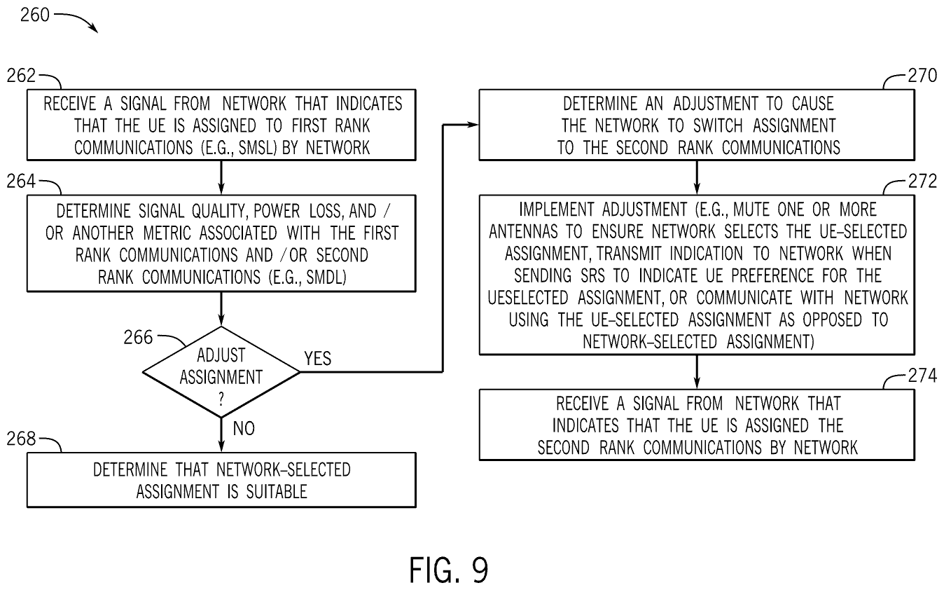

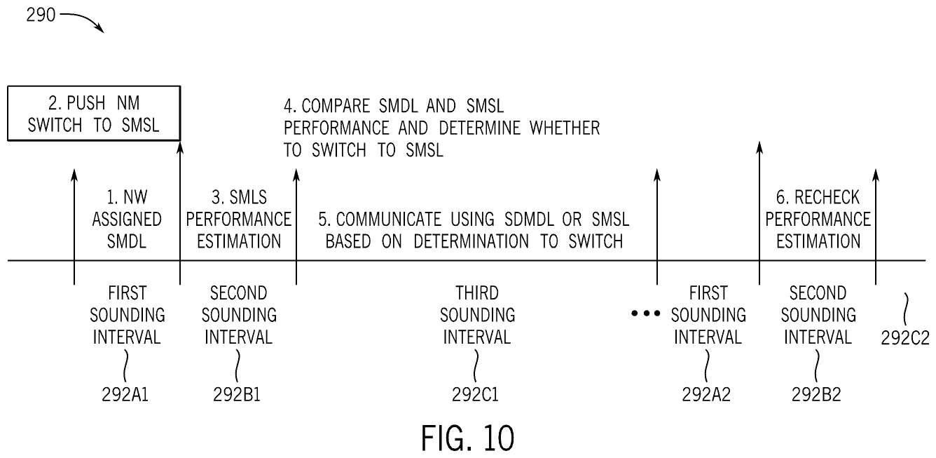

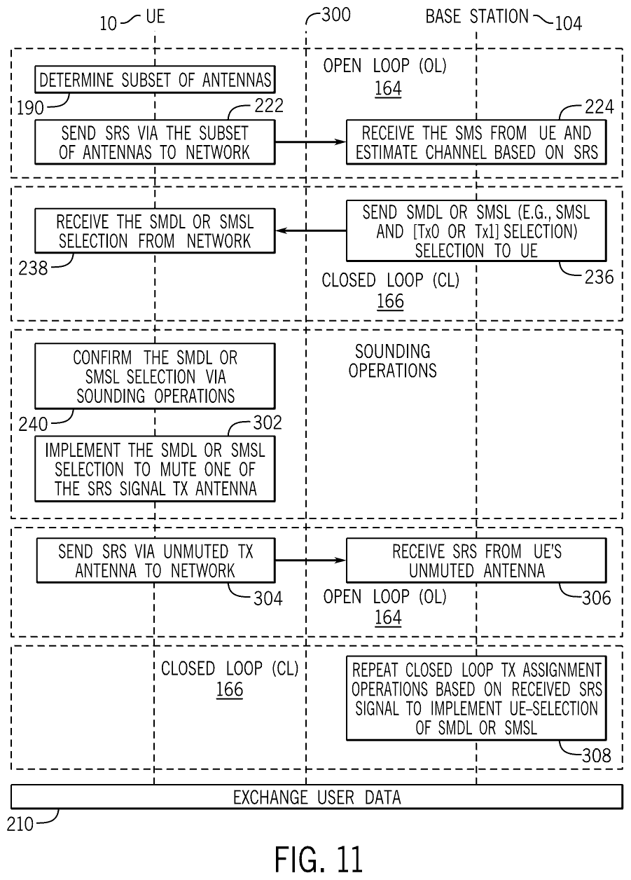

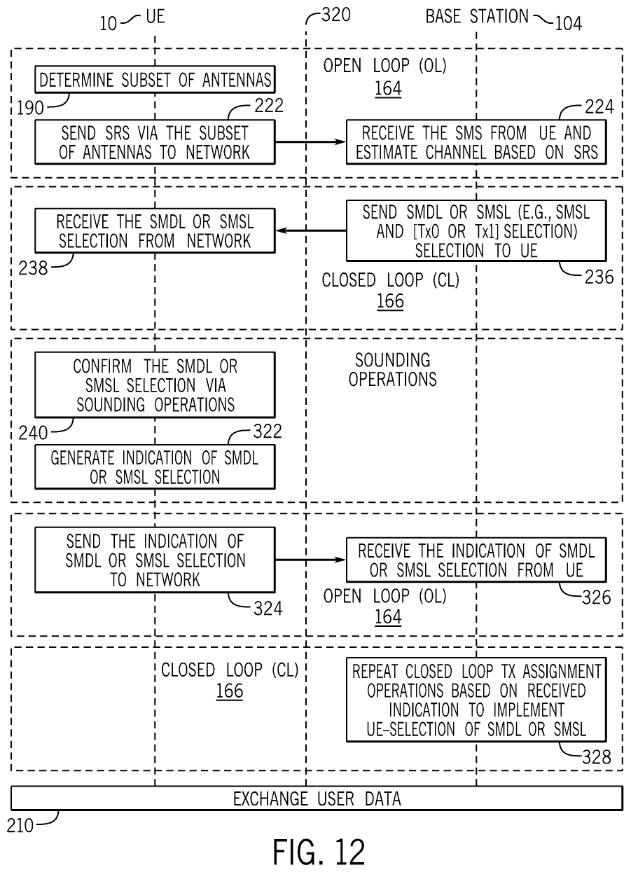

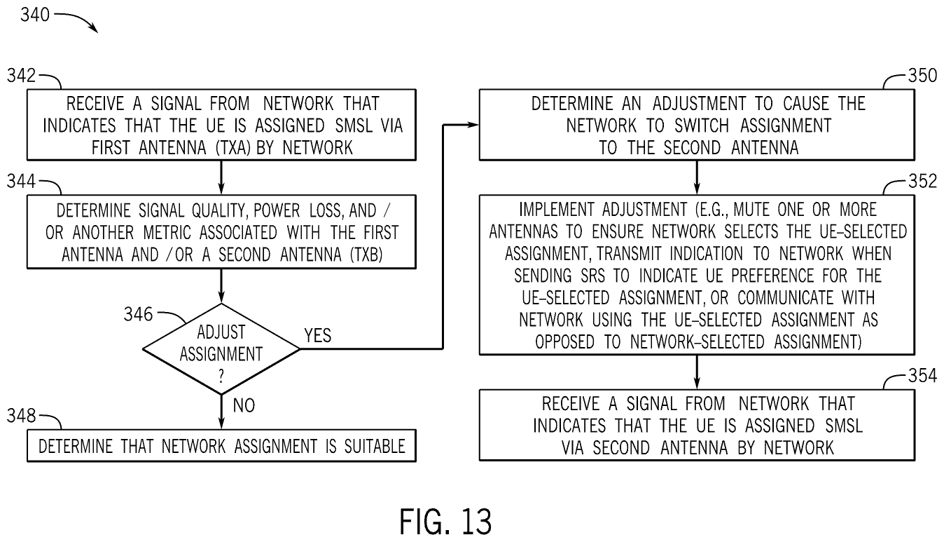

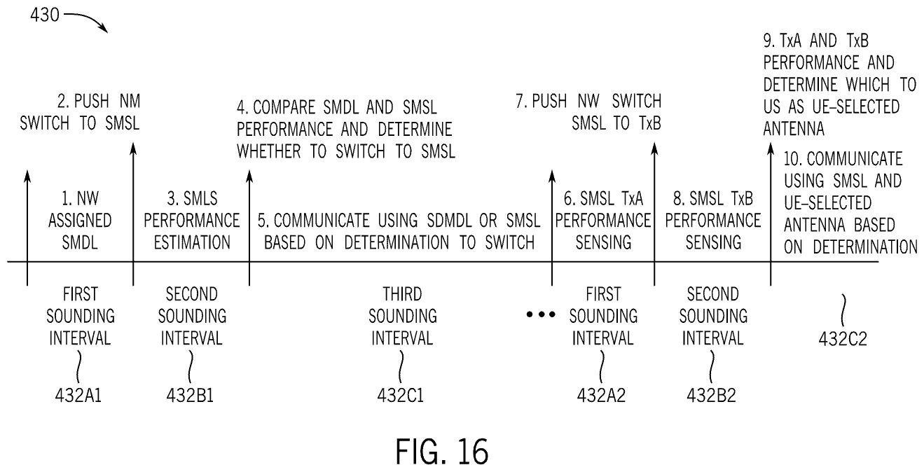

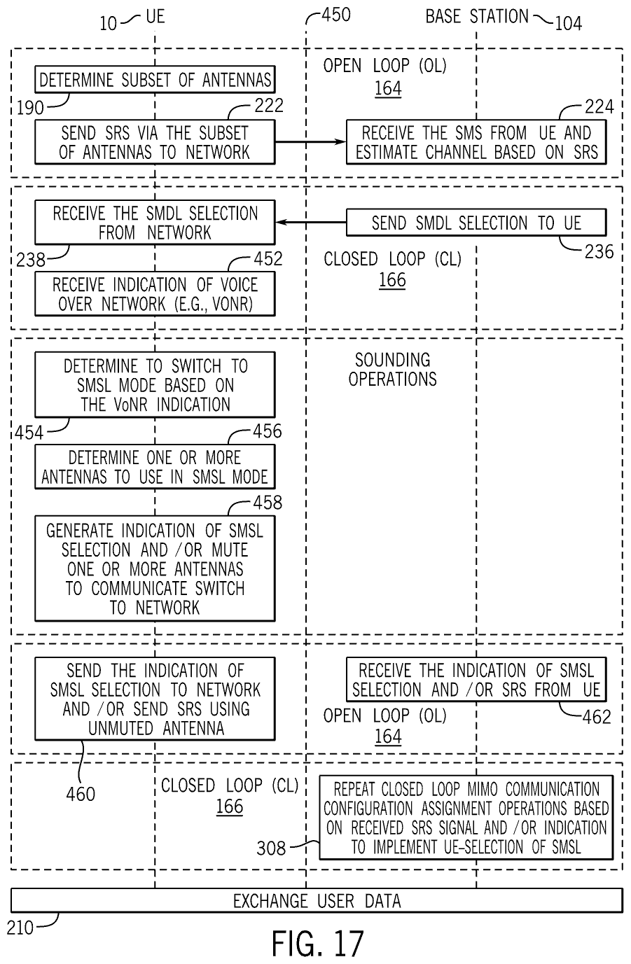

At process block 240, the electronic device 10 confirms the selections from the base station 104 using sounding operations. The base station 104 may select channel 1 (e.g., antenna A) so the electronic device 10 may sound the other channel 2 (e.g., antenna B) to compare the performance of the respective channels and select the relatively more suitable channel among the options to switch the base station 104. To cause the switch in channels at the network 102 side, the electronic device 10 may mute the channel 1 when sending an SRS signal (e.g., operations of FIG. 11), may add a new indication to communicate that the channel 2 is the preferred channel by the electronic device 10 (e.g., operations of FIG. 12), may transmit using the channel 2 without notifying the base station 104, or the like. The sounding operations may enable the electronic device 10 to identify its preference among the antennas 55, cause the switch even after the base station 104 has selected between SMDL or SMSL, such as when sounding operations are performed according to sensing intervals (e.g., operations of FIG. 10). The sounding operations may be used to confirm any of the selections by the base station 104. For example, the sounding operations may confirm SMDL selection v. SMSL selection at the electronic device 10 (e.g., operations of FIGS. 9-12), a first channel selection v. a second channel selection at the electronic device 10 (e.g., operations of FIGS. 13-15), to confirm both (e.g., operations of FIGS. 16-17), or the like. Once confirmed, at process block 242, the electronic device 10 implements the selections from the base station 104. This may involve generating one or more control signals to prepare one or more antennas 55 (or other circuitry of transceiver 30) to implement one or more data layers based on the SMDL mode or the SMSL mode selection. At process block 230, the electronic device 10 and the base station 104 may communicate according to the base station 104 selections which have been confirmed by the user equipment as suitable.

To elaborate on the sounding operations, FIG. 9 is a flowchart of a method 260 corresponding to the sounding operations of FIG. 8 that may be performed to confirm the selected number of data layers (e.g., SMSL v. SMDL), according to embodiments of the present disclosure. Any suitable device (e.g., a controller) that may control components of the electronic device 10, such as the processor 12A, may perform the method 260. In some embodiments, the method 260 may be implemented by executing instructions stored in a tangible, non-transitory, computer-readable medium, such as the memory 14 or storage 16, using the processor 12A. For example, the method 260 may be performed at least in part by one or more software components, such as an operating system of the electronic device 10, one or more software applications of the electronic device 10, and the like. While the method 260 is described using steps in a specific sequence, it should be understood that the present disclosure contemplates that the described steps may be performed in different sequences than the sequence illustrated, and certain described steps may be skipped or not performed altogether.

At process block 262, the electronic device 10 receives a signal from the base station 104 that indicates that the electronic device 10 is assigned to first rank communications (e.g., SMSL) by network. At process block 264, in response to the signal, the electronic device 10 determines signal quality, power loss, and/or another metric associated with the first rank communications (SMSL) and/or second rank communications (SMDL). These operations are sounding operations to confirm the selection of the mode by the base station 104. At processing block 266, the electronic device 10 may determine whether to adjust the selection from the base station 104 (e.g., assignment to SMSL). In response to determining to not adjust the selection, at process block 268, the electronic device 10 determines that the network-selected assignment to SMSL mode is suitable for the electronic device 10. In response to determining to adjust the selection, at process block 270, the electronic device 10 determines an adjustment to cause the base station 104 to switch the assignment from SMSL to the second rank communications (e.g. SMDL mode). At process block 272, the electronic device 10 implements the adjustment. At block 274, the electronic device 10 may receive a signal from the base station 104, where the signal may indicate that the electronic device 10 is assigned the second rank communications by the base station 104. The electronic device 10 may implement the adjustment to the SMDL mode based on muting one or more antennas 55 to ensure the base station 104 selects the UE-selected assignment of SMDL mode. For example, the electronic device 10 may mute or unmute one or more antennas 55 when sending an additional SRS (e.g., additional SRS combination) to the base station 104 to cause the base station 104 to select a different MIMO communication mode or a different communication channel (e.g., channel corresponding to Tx0, channel corresponding to Tx1). The electronic device 10 may implement the adjustment based on transmitting an indication to the base station 104 to indicate a preference for the UE-selected assignment of SMDL mode. The indication may be a “R16 UAI UL MIMO preferred port” indication to indicate channel 2 (e.g., antenna B) preference to the base station 104. The electronic device 10 may implement the adjustment based on communicating with the base station 104 using the UE-selected assignment of SMDL mode as opposed to network-selected assignment. In some systems, the electronic device 10 may switch a network 102 selection of SMDL to SMSL and may not switch a network 102 selection of SMSL to SMDL. Furthermore, in some systems, operations of FIG. 9 are aligned to timing intervals.

To elaborate on the timing intervals, FIG. 10 is a diagrammatic representation 290 of the method corresponding to the sounding operations of FIGS. 8-9 used to confirm the selected number of data layers (confirm SMSL mode or SMDL mode) as aligned to example timing intervals 292, according to embodiments of the present disclosure. It should be understood that although specific operational process blocks are not called out specifically herein, some disclosure related to FIGS. 8-9 may be referred to herein in the discussion of FIG. 10. Operations of FIG. 10 may correspond to operations performed in association with process block 266 of FIG. 9 to determine whether or not to change the selection of SMDL mode or SMSL mode by base station 104.

Timing intervals 292A (292A1, 292A2) correspond to a first sounding interval. Timing intervals 292B (292B1, 292B2) correspond to a second sounding interval. Timing intervals 292C (292C1, 292C2) correspond to a third sounding interval relatively longer in duration than the first sounding interval and the second sounding interval.

At the start of timing interval 292A1, the electronic device 10 receives indication that the network (e.g., base station 104) assigned SMDL mode using operations of FIG. 8. At the start of the timing interval 292B1, the electronic device 10 causes the network 102 to switch to SMSL mode from the SMDL mode using operations of block 272 of FIG. 9. Once switched, the electronic device 10 implements the SMSL selection in its RF circuitry (e.g., of FIGS. 3-4). The electronic device 10 during the second sounding interval (e.g., timing interval 292B1) performs a SMSL performance estimation. At the start of the timing interval 292C1, the electronic device 10 determines whether the SMSL mode or the SMDL mode produced greater transmit power levels from its RF circuitry. During the timing interval 292C1, the electronic device 10 communicates using SMSL mode or SMDL mode based on the determination to switch, which includes pushing the network 102 to switch its assignment back to SMDL mode should the electronic device 10 determine that performance was better in that mode.

The user equipment may periodically recheck antenna 55 performance to ensure that the greatest power levels are being used and/or the improve performance overtime by recalibrating when determined useful. Thus, at the beginning of the second timing interval 292B2, the electronic device 10 may recheck the performance estimation and compare current performance of the selected mode used in operations between the timing interval 292C2 and timing interval 292A2 to the other mode option. This may involve repeating operations corresponding to timing intervals 292A1, 292B1, and 292C1. Thus, FIG. 10 illustrates an example of rank (e.g., single layer (SMSL) or dual layer (SMDL)) sounding operations to confirm the base station 104 assignment of SMDL or SMSL as aligned to sounding intervals.

As noted above, the electronic device 10 may cause the base station 104 to switch its selected mode. To do so the electronic device 10 may mute one or more antennas 55 used to send an original SRS to change the new SRS received by the base station 104, triggering the switch.

To elaborate, FIG. 11 is a flowchart of a method 300 performed to switch a data layer selection based on the sounding operations of FIG. 8, where the switching is based on the electronic device 10 muting one or more antennas as part of a repeated open loop operation, according to embodiments of the present disclosure. Any suitable device (e.g., a controller) that may control components of electronic devices, such as the processor 12A, may perform some of the method 300. Some of the method 300 may be performed by electronic device 10 via processors 12A and some of the method 300 may be performed by electronic devices associated with the network 102, such as the base station 104 via a processor 12B. In some embodiments, the method 300 may be implemented by executing instructions stored in a tangible, non-transitory, computer-readable medium, such as the memory 14 or storage 16, using the processor 12A. For example, the method 300 may be performed at least in part by one or more software components, such as an operating system of the electronic device 10, one or more software applications of the electronic device 10, and the like. While the method 300 is described using steps in a specific sequence, it should be understood that the present disclosure contemplates that the described steps may be performed in different sequences than the sequence illustrated, and certain described steps may be skipped or not performed altogether.

Some operations of the method 300 are operations of method 220 of FIG. 8 and these descriptions are relied upon herein and use the same reference numerals. This may include omitted operations, such as SMDL mode v. SMSL mode selection operations illustrated in FIG. 8 but omitted between process block 224 and process block 236 in FIG. 11.

At process block 240, the electronic device 10 confirms or switches the SMDL mode or SMSL mode selection received from the base station 104 based on performing the sounding operations. At process block 302, the electronic device 10 implements the SMDL mode or SMSL mode selection by muting one of the antennas 55 used to transmit the SRS signal at process block 222. At block 304, the electronic device 10 may send the SRS to the base station 104 via the unmuted of the antenna 55. By muting at least one antenna 55 used to the transmit the SRS signal, the electronic device 10 is changing one or signal characteristics of the SRS signal (relative to the original SRS signal transmitted at process block 222) to cause a change in processing at the network-side.

The base station 104 may receive the adjusted SRS signal at process block 306. At process block 308, the base station 104 may repeat closed loop operations 166 based on received adjusted SRS signal to implement UE-selection of the SMDL mode or the SMSL mode. Indeed, this may involve a transceiver of the base station 104 receiving the adjusted SRS (e.g., a second SRS if one was already received earlier). Based on the adjusted SRS, the base station 104 may communicate with the electronic device 10 according to the SMDL mode via the first data layer and the second data layer based on the second SRS. The base station 104 may determine this without also considering any previously transmitted indications communicating a transmission power difference between one or more antennas 55 of the electronic device 10.

At process block 210, the electronic device 10 and the base station 104 exchange user data according to the UE-selected of the SMDL mode or the SMSL mode. In this way, the electronic device 10 causes the base station 104 to switch its mode selection from what the base station 104 originally sent at process block 236 to what the electronic device 10 selected at process block 240.

In some cases, the electronic device 10 may be working in the SMDL mode and the reference signal received power (RSRP) may be lower than a threshold (in decibel-milliwatts (dBm)) (e.g., −110 dBm, between −110 dBm and −130 dBm, substantially around −110 dBm, between −115 dBm and −105 dBm), and thus may justify communicating in the SMSL mode. The electronic device 10 may use the sounding operations to confirm transmit power levels from one or more candidate antennas meet power level specifications, where power levels may correspond to a MTPL value.

As noted above, the electronic device 10 may cause the base station 104 to switch its selected mode. To do so the electronic device 10 may transmit an indication to the base station 104 communicating the UE-selected mode preference (e.g., “R16 UAI UL MIMO Reduction” indication), triggering the switch.

To elaborate, FIG. 12 is a flowchart of a method 320 performed to switch a data layer selection based on the sounding operations of FIG. 8, where the switching is based on the electronic device 10 sending an indication of its data layer selection as part of a repeated open loop operation, according to embodiments of the present disclosure. Any suitable device (e.g., a controller) that may control components of the electronic devices, such as the processor 12A, may perform some of the method 320. Some of the method 320 may be performed by electronic device 10 via processors 12A and some of the method 320 may be performed by electronic devices associated with the network 102, such as the base station 104 via a processor 12B. In some embodiments, the method 320 may be implemented by executing instructions stored in a tangible, non-transitory, computer-readable medium, such as the memory 14 or storage 16, using the processor 12A. For example, the method 320 may be performed at least in part by one or more software components, such as an operating system of the electronic device 10, one or more software applications of the electronic device 10, and the like. While the method 320 is described using steps in a specific sequence, it should be understood that the present disclosure contemplates that the described steps may be performed in different sequences than the sequence illustrated, and certain described steps may be skipped or not performed altogether.

Some operations of the method 320 are operations of method 220 of FIG. 8 and these descriptions are relied upon herein and use the same reference numerals. This may include omitted operations, such as SMDL mode v. SMSL mode selection operations illustrated in FIG. 8 but omitted between process block 224 and process block 236 in FIG. 12.

At process block 240, the electronic device 10 confirms or switches the SMDL mode or SMSL mode selection received from the base station 104 based on performing the sounding operations. At process block 322, the electronic device 10 implements the SMDL mode or SMSL mode selection by generating an indication of its selection made via the sounding operations. Indeed, the electronic device 10 may transmit an indication of its selection to the base station 104 by transmitting a “R16 UAI UL MIMO Reduction” indication. At process block 324, the electronic device 10 sends the indication to the base station 104.

At process block 326, the base station 104 may receive the indication from the electronic device 10. At process block 328, the base station 104 may repeat the closed loop operations 166 of FIG. 8 based on received indication to implement UE-selection of the SMDL mode or SMSL mode. in some cases, the indication transmitted by the electronic device 10 may communicate a preference to the base station 104 that is considered along with other network 102 parameters and/or other user equipment parameters to better select which of the SMDL mode or SMSL mode to use with that electronic device 10.

With the foregoing in mind, similar to how the base station 104 may select an undesirable number of data layers (e.g., SMDL mode v. SMSL mode), sometimes the base station 104 selects a channel (e.g., Tx0 v. Tx1) assignment that may result in less than maximum transmit power in signals transmitted by the electronic device 10. Several methods are described here to determine whether to switch from the base station 104 assignment and, if so, how to switch.

FIG. 13 is a flowchart of a method 340 corresponding to the sounding operations of FIG. 8 that may be performed to confirm a channel (e.g., antenna) selection associated with a single data layer selection (SMSL mode) associated with the communication initialization method of FIG. 7, according to embodiments of the present disclosure. Any suitable device (e.g., a controller) that may control components of the electronic device 10, such as the processor 12A, may perform the method 340. In some embodiments, the method 340 may be implemented by executing instructions stored in a tangible, non-transitory, computer-readable medium, such as the memory 14 or storage 16, using the processor 12A. For example, the method 340 may be performed at least in part by one or more software components, such as an operating system of the electronic device 10, one or more software applications of the electronic device 10, and the like. While the method 340 is described using steps in a specific sequence, it should be understood that the present disclosure contemplates that the described steps may be performed in different sequences than the sequence illustrated, and certain described steps may be skipped or not performed altogether.

At process block 342, the electronic device 10 receives a signal from the base station 104 that indicates that the electronic device 10 is assigned to first rank communications (e.g., SMSL) by network 102 and a first channel corresponding to a first antenna 55. At process block 344, in response to the signal, the electronic device 10 determines signal quality, power loss, and/or another metric associated with the first rank communications (SMSL) based on the first channel and first antenna 55 and based on the second channel and a second antenna 55. These operations are sounding operations to confirm the selection of the channel associated with the SMSL mode selection of the base station 104. At processing block 346, the electronic device 10 may determine whether to adjust the selection from the base station 104 (e.g., assignment to SMSL Tx0 or Tx1). In response to determining to not adjust the selection, at process block 348, the electronic device 10 determines that the network-selected assignment to SMSL mode and the first antenna 55 is suitable for the electronic device 10. In response to determining to adjust the selection, at process block 350, the electronic device 10 determines an adjustment to cause the base station 104 to switch the assignment from the first antenna 55 to the second antenna 55 (Tx1) and SMSL mode. At process block 352, the electronic device 10 implements the adjustment. The electronic device 10 may implement the adjustment to the SMSL mode and second antenna 55 based on muting one or more antennas 55 to ensure the base station 104 selects the UE-selected assignment of SMSL mode and second antenna 55. The electronic device 10 may implement the adjustment based on transmitting an indication to the base station 104 to indicate a preference for the UE-selected assignment of SMSL mode and second antenna 55. The indication may be a “R16 UAI UL MIMO preferred port” indication to indicate the second antenna 55 (e.g., second channel) preference to the base station 104. The electronic device 10 may implement the adjustment based on communicating with the base station 104 using the UE-selected assignment of SMDL mode as opposed to network-selected assignment. In some systems, the electronic device 10 may change a network 102 selection of SMDL mode to SMSL mode and may not change a network 102 selection of the reverse (of SMSL mode to SMDL mode). Furthermore, in some systems, operations of FIG. 9 are aligned to timing intervals. At block 354, the electronic device 10 receives a signal from the base station 104 that indicates that the electronic device 10 is assigned to SMSL mode and the second antenna 55 by the base station 104, confirming that the switch is implemented and ready for communications (e.g., process block 210 exchange user data operations). In some systems, operations of FIG. 13 are aligned to timing intervals.

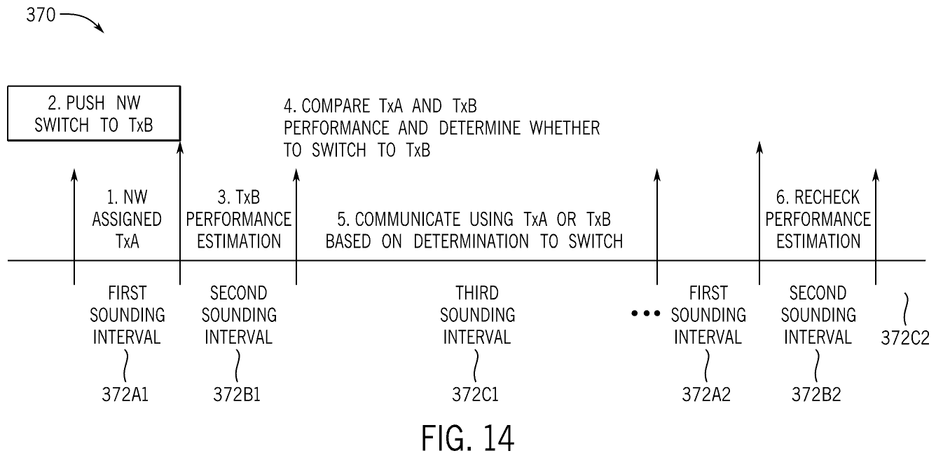

To elaborate on the timing intervals, FIG. 14 is a diagrammatic representation 370 of the method corresponding to the sounding operations of FIGS. 8-9 used to confirm the selected channel (confirm first antenna 55 or second antenna 55) as aligned to example timing intervals 372, according to embodiments of the present disclosure. It should be understood that although specific operational process blocks are not called out specifically herein, some disclosure related to FIGS. 8-13 may be referred to herein in the discussion of FIG. 14. Operations of FIG. 14 may correspond to operations performed in association with process block 346 of FIG. 13 to determine whether or not to change the selection of a channel by base station 104.

Timing intervals 372A (372A1, 372A2) correspond to a first sounding interval. Timing intervals 372B (372B1, 372B2) correspond to a second sounding interval. Timing intervals 372C (372C1, 372C2) correspond to a third sounding interval relatively longer in duration than the first sounding interval and the second sounding interval.

At the start of timing interval 372A1, the electronic device 10 receives indication that the network (e.g., base station 104) assigned SMSL mode and a first channel (e.g., TxA) using operations of FIG. 8. At the start of the timing interval 372B1, the electronic device 10 pushes the network 102 to switch to SMSL mode and a second channel (e.g., TxB) from the first channel. Once switched, the electronic device 10 implements the SMSL mode and second channel selection in its RF circuitry (e.g., of FIGS. 3-4). The electronic device 10 during the second sounding interval (e.g., timing interval 372B1) performs a second channel performance estimation. At the start of the timing interval 372C1, the electronic device 10 determines whether the SMSL mode with the first channel or the SMSL mode with the second channel produced greater transmit power levels from its RF circuitry. During the timing interval 372C1, the electronic device 10 communicates using SMSL mode with the first channel or the SMSL mode with the second channel based on the determination to switch, which includes pushing the network 102 to switch its assignment back to SMSL mode with the first channel should the electronic device 10 determine that performance was better in that mode and channel combination.

The user equipment may periodically recheck antenna 55 performance to ensure that the greatest power levels are being used and/or the improve performance overtime by recalibrating when determined useful. Thus, at the beginning of the second timing interval 372B2, the electronic device 10 may recheck the performance estimation and compare current performance of the selected mode used in operations between the timing interval 372C2 and timing interval 372A2 to the other mode option. This may involve repeating operations corresponding to timing intervals 372A1, 372B1, and 372C1. Thus, FIG. 10 illustrates an example of channel (e.g., single layer (SMSL) first channel or SMSL second channel) sounding operations to confirm the base station 104 assignment of first channel or second channel as aligned to sounding intervals.

As noted above, the electronic device 10 may cause the base station 104 to switch its selected channel. To do so the electronic device 10 may mute one or more antennas 55 used to send an original SRS to change the new SRS received by the base station 104, triggering the switch. In some systems, the electronic device 10 may transmit an indication of its channel selection to the base station 104, which the base station 104 may switch to or switch based on. In some systems, the electronic device 10 may communicate with the base station 104 using its selected channel and may not notify the base station 104 of the change. The base station 104 may align its communications to the selected channel without reperforming the SRS reception operations and/or recalibrate to the changed channel.

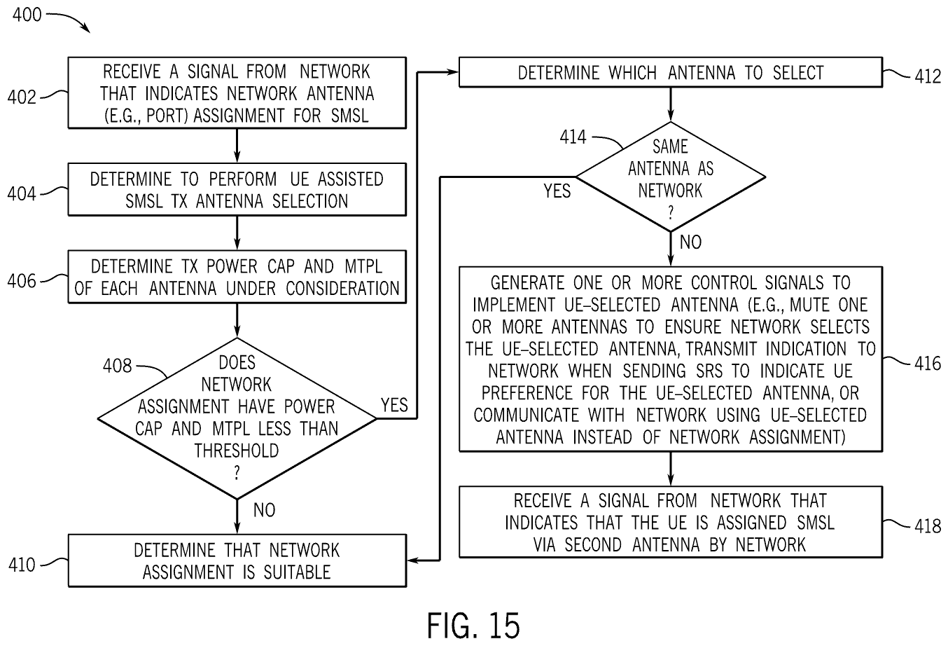

With the foregoing in mind, FIG. 15 illustrates a particular example of the operations described herein. FIG. 15 is a flowchart of another example method 400 corresponding to the sounding operations of process block 240 of FIG. 8 that may be performed to confirm a channel selection associated with a single data layer selection (SMSL mode) associated with the communication initialization method of FIG. 6 based on a transmission power maximum and a maximum transmit power level (MTPL) associated with one or more antennas 55, according to embodiments of the present disclosure. Any suitable device (e.g., a controller) that may control components of the electronic device 10, such as the processor 12A, may perform the method 400. In some embodiments, the method 400 may be implemented by executing instructions stored in a tangible, non-transitory, computer-readable medium, such as the memory 14 or storage 16, using the processor 12A. For example, the method 400 may be performed at least in part by one or more software components, such as an operating system of the electronic device 10, one or more software applications of the electronic device 10, and the like. While the method 400 is described using steps in a specific sequence, it should be understood that the present disclosure contemplates that the described steps may be performed in different sequences than the sequence illustrated, and certain described steps may be skipped or not performed altogether.

At process block 402, the electronic device 10 receives a signal from network 102 that indicates network 102 antenna (e.g., channel, port, antenna) assignment for the SMSL mode. For example, the base station 104 may transmit an indication of a network-selected MIMO communication mode (e.g., SMSL mode) and a network-selected channel (e.g., Tx0 or Tx1) to the electronic device 10. At process block 404, the electronic device 10 determines to perform UE-assisted SMSL TX antenna selection. To do so in this example, the electronic device 10 considers power capping and MTPLs of one or more antennas 55.

To elaborate, at process block 406, the electronic device 10 determines a maximum power threshold for a transmit signal (e.g., power cap) and the MTPL of each antenna 55 under consideration. At process block 408, the electronic device 10 determines whether the network-assigned channel (e.g., port) has a maximum power threshold less than its maximum power threshold and/or a MTPL less than its MTPL determined for one or more antennas at process block 406. The electronic device 10 may use these operations to evaluate whether using the network 102 selections is suitable. In response to determining that the network-assigned channel is not power capped, at process block 410, the electronic device 10 determines that the network 102 selections of SMSL mode and the network-assigned channel is suitable. However, in response to determining that the network-assigned channel is power capped, at process block 412, the electronic device 10 determines that the network 102 selections of SMSL mode and the network-assigned channel is not suitable and determines which antenna 55 to select. At process block 414, the electronic device 10 determines whether it selected the same channel as the network 102. If the electronic device 10 selected the same channel, at process block 410, the user equipment determines that the network 102 assignment is suitable and may continue on to communicate via the network 102, such as to exchange user data at process block 210 of FIG. 8.

In response to the electronic device 10 at process block 414 determining that it selected a different channel or antenna 55 than the network 102, at process block 416, the electronic device 10 generates one or more control signals to implement the UE-selected channel or UE-selected antenna 55. For example, the electronic device 10 may generate one or more control signals to mute one or more antennas 55 to cause the base station 104 to select the UE-selected antenna. The electronic device 10 may generate one or more control signals to transmit an indication to the network 102 when sending an additional SRS (e.g., to trigger repeat of open loop operations 164 operations of FIG. 8) to indicate the UE-selected antenna 55. The indication may be a “R16 UAI UL MIMO preferred port” indication to indicate the selected antenna 55 (e.g., selected channel) as a preference or selection to the base station 104. In some cases, the electronic device 10 may communicate via the network 102 using UE-selected antenna 55 instead of the network-selected antenna 55 without causing the base station 104 to switch its assignment and/or without sending an indication of the change to the network 102. The electronic device 10 may implement the adjustment based on communicating with the base station 104 using the UE-selected assignment of SMDL mode as opposed to network-selected assignment. At block 418, the electronic device 10 may receive a signal from the base station 104, where the signal may indicate that the electronic device 10 is assigned SMSL via the second antenna by the base station 104. It is noted that these descriptions may be used similarly at process block 352 of FIG. 13 when signaling channel selections and/or antenna selections to the network 102. The method 400 may continue to operations of FIG. 8 at process block 210. Indeed, at process block 210 of FIG. 8, the electronic device 10 may exchange user data using the selected or confirmed MIMO communication configuration (e.g., SMDL mode or SMSL mode selection and channel selection). Similar to other operations, some of these operations of method 400 may be performed aligned to various sensing intervals and/or repeated to switch between network 102 assignments and UE-selections for MIMO communication configurations.

FIG. 16 is a diagrammatic representation 430 of the method corresponding to the sounding operations of FIGS. 8, 9, and 13 used to confirm the selected number of data layers and the channel selection, according to embodiments of the present disclosure. Some operations are repeated herein relative to diagrammatic representations of FIG. 14 and FIG. 10, and thus these descriptions are relied on herein. FIG. 16 illustrates a double-switching operation, where the electronic device 10 confirms the assignment to SMSL mode or SMDL mode, and when SMSL mode to the first channel or the second channel (e.g., the first antenna 55 or the second antenna 55). It should be understood that although specific operational process blocks are not called out specifically herein, some disclosure related to FIGS. 8-15 may be referred to herein in the discussion of FIG. 16. Operations of FIG. 14 may correspond to operations performed in association with process block 346 of FIG. 13 to determine whether or not to change the selection of SMDL mode or SMSL mode by base station 104 and/or to determine whether or not to change the selection of a channel by base station 104. Thus, FIG. 16 may illustrate how various methods of FIGS. 8-15 may be combined into the same systems and methods.

Timing intervals 432A (432A1, 432A2) correspond to a first sounding interval. Timing intervals 432B (432B1, 432B2) correspond to a second sounding interval. Timing intervals 432C (432C1, 432C2) correspond to a third sounding interval relatively longer in duration than the first sounding interval and the second sounding interval.

At the start of timing interval 292A1, the electronic device 10 receives indication that the network (e.g., base station 104) assigned SMDL mode using operations of FIG. 8. At the start of the timing interval 292B1, the electronic device 10 causes the network 102 to switch to SMSL mode from the SMDL mode using operations of block 272 of FIG. 9. Once switched, the electronic device 10 implements the SMSL selection in its RF circuitry (e.g., of FIGS. 3-4). The electronic device 10 during the second sounding interval (e.g., timing interval 292B1) performs a SMSL performance estimation. At the start of the timing interval 292C1, the electronic device 10 determines whether the SMSL mode or the SMDL mode produced greater transmit power levels from its RF circuitry. During the timing interval 292C1, the electronic device 10 communicates using SMSL mode or SMDL mode based on the determination to switch, which includes pushing the network 102 to switch its assignment back to SMDL mode should the electronic device 10 determine that performance was better in that mode.

The electronic device 10 may periodically recheck antenna 55 performance to ensure that maximum or as high as expected power levels are being used and/or the improve performance overtime by recalibrating when determined useful. These rechecked antenna 55 performances may include confirming a channel selection. When performed immediately sequential to a MIMO communication mode selection confirmation, the electronic device 10 may confirm or change the channel selection made by the base station 104 as part of assignment operations corresponding to the timing interval 432A1. Thus, at the beginning of the second timing interval 292B2, the electronic device 10 may perform SMSL mode performance sensing for a first channel (e.g., TxA when assigned by the base station 104 for operations of third timing interval 432C1). At the start of the timing interval 432B2, the electronic device 10 pushes the network 102 to switch to SMSL mode and a second channel (e.g., TxB) from the first channel. Once switched, the electronic device 10 implements the SMSL mode and second channel selection in its RF circuitry (e.g., of FIGS. 3-4). The electronic device 10 during the second sounding interval (e.g., timing interval 432B2) performs a second channel performance estimation. At the start of the timing interval 432C2, the electronic device 10 determines whether the SMSL mode with the first channel or the SMSL mode with the second channel produced greater transmit power levels from its RF circuitry. During the timing interval 432C2, the electronic device 10 communicates using SMSL mode with the first channel or the SMSL mode with the second channel based on the determination to switch, which includes pushing the network 102 to switch its assignment back to SMSL mode with the first channel should the electronic device 10 determine that performance was better in that mode and channel combination.

The electronic device 10 may periodically recheck antenna 55 and SMSL/SMDL mode performance to ensure that the greatest power levels are being used and/or the improve performance overtime by recalibrating when desired. Thus, after the third timing interval 432C2, the electronic device 10 may recheck the performance estimation and compare current performance of the selected mode and/or selected channel (or antenna). This may involve repeating operations corresponding to timing intervals 372A1, 372B1, and 372C1. Thus, FIG. 16 illustrates an example of rank and channel (e.g., single layer (SMSL) first channel or SMSL second channel) sounding operations to confirm the base station 104 assignment of MIMO communication mode and/or the base station 104 assignment of first channel or second channel as aligned to sounding intervals.

As noted above, the electronic device 10 may cause the base station 104 to switch its selected channel. To do so the electronic device 10 may mute one or more antennas 55 used to send an original SRS to change the new SRS received by the base station 104, triggering the switch. In some systems, the electronic device 10 may transmit an indication of its channel selection to the base station 104, which the base station 104 may switch to or switch based on. In some systems, the electronic device 10 may communicate with the base station 104 using its selected channel and may not notify the base station 104 of the change. The base station 104 may align its communications to the selected channel without reperforming the SRS reception operations and/or recalibrate to the changed channel. However, other operations may be used similar as to how described at process block 416 of FIG. 15.

In some cases, the electronic device 10 communicates via the network 102 using a Voice-over-Cellular (e.g., Voice-over-New-Radio (NR) (VONR)) communications. Since the electronic device 10 may not signal this capability to the network 102 before the MIMO communication mode is selected, sometimes the base station 104 selects the SMDL mode when the SMSL mode is more efficient for Voice-over-Cellular communications (e.g., VoNR communications). Thus, the electronic device 10 may switch SMDL mode selections to SMSL mode selections.

To elaborate, FIG. 17 is a flowchart of a method 450 that include sounding operations to confirm MIMO communication configuration generated by the base station 104, such as described herein relative to FIGS. 8-16, and as applied to the Voice-over-Cellular (e.g., VoNR) example, according to embodiments of the present disclosure. Any suitable device (e.g., a controller) that may control components of the electronic devices, such as the processor 12A, may perform some of the method 450. Some of the method 450 may be performed by electronic device 10 via processors 12A and some of the method 450 may be performed by electronic devices associated with the network 102, such as the base station 104 via a processor 12B. In some embodiments, the method 450 may be implemented by executing instructions stored in a tangible, non-transitory, computer-readable medium, such as the memory 14 or storage 16, using the processor 12A. For example, the method 450 may be performed at least in part by one or more software components, such as an operating system of the electronic device 10, one or more software applications of the electronic device 10, and the like. While the method 450 is described using steps in a specific sequence, it should be understood that the present disclosure contemplates that the described steps may be performed in different sequences than the sequence illustrated, and certain described steps may be skipped or not performed altogether.

At process blocks 190, 222, 224, 236, and 238, the electronic device 10 and the base station 104 repeat operations described in FIG. 8, including operations of process blocks 226, 230, 228, 232, and/or 234, to enable the electronic device 10 receive, at process block 238, the SMDL mode selection from the base station 104. At process block 452, the electronic device 10 receives an indication that the Voice-over-Cellular communications (e.g., VoNR communications) are to occur with the base station 104. The indication may be received from the processor 12A anticipating a type of communication being generated by the electronic device 10, reading an indication from the cell corresponding to the base station 104 (e.g., operations of blocks 182-188 of FIG. 8 to determine system configurations of the base station 104), receiving the indication from memory 14, or the like. Since the SRS transmitted at process block 222 may exclude information related to whether the electronic device 10 plans to use the Voice-over-Cellular communications (e.g., VoNR communications), the electronic device 10 may perform sounding operations to confirm and/or switch the MIMO communication configurations sent by the base station 104. At process block 454, the electronic device 10 determines to switch the SMDL mode to a SMSL mode based on the indication of process block 452. To do so, at process block 456, the electronic device 10 determines one or more antennas 55 to use in single data layer communications corresponding to the SMSL mode. One or more antennas 55 may be selected in case that transmit (TX) diversity is desired to be used in future communications (e.g., operations of FIGS. 29-32). One or more operations described relative to FIGS. 8-16 may be performed in association with operations of process block 456 to enable the electronic device 10 to select the antennas 55.

At process block 458, the electronic device 10 implements the SMSL mode selection using operations similar to those described in process block 242 of FIG. 8. For example, at process block 458, the electronic device 10 generates an indication of the SMSL mode selection to send and/or mutes one or more antennas 55 when sending an additional SRS (e.g., additional SRS combination) to the base station 104. The indication may correspond to a new UAI signal of “R16 UAI UL MIMO Reduction,” which the network 102 may reference to switch to single data layer communications. At process block 460, the electronic device 10 sends the indication of the SMSL mode selection to the base station 104 and/or sends the additional SRS to the base station 104 using an unmuted antenna 55. At process block 462, the base station 104 receives the indication of the SMSL mode selection and/or the additional SRS. In response to the indication, the base station 104 may determine the selected channel from the electronic device 10 and the SMSL mode selection from the indication. In response to the additional SRS, the base station 104 may repeat estimating the channel based on the SRS (using the additional SRS as the SRS in operations described at process block 224). Indeed, at process block 308, the base station 104 repeats MIMO communication configuration assignment operations from open loop operations 164 and/or closed loop operations 166 based on the received SRS signal and/or the indication of the UE-selected SMSL mode. It is noted that these descriptions may be used similarly at process block 416 of FIG. 15 when signaling channel selections and/or antenna selections to the network 102.

The method 450 may continue to operations of FIG. 8 at process block 210. Indeed, at process block 210 of FIG. 8, the electronic device 10 may exchange user data using the selected or confirmed MIMO communication configuration (e.g., SMDL mode or SMSL mode selection and channel selection). Similar to other operations, some of these operations of method 450 may be performed aligned to various sensing intervals and/or repeated to switch between network 102 assignments and UE-selections for MIMO communication configurations.

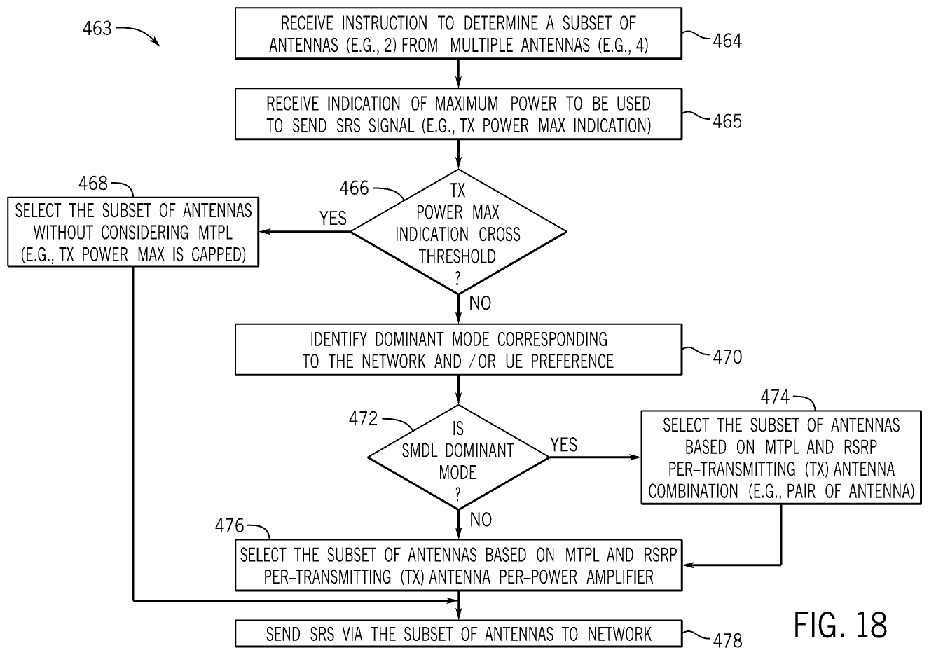

Keeping the foregoing in mind, FIGS. 18-22 may relate to MIMO communication configuration generation, which combines open loop operations 164 and closed loop operations 166. On the electronic device 10 side, the open loop operations 164 selection of a subset of antennas 55 occurs, such as to select two antennas from four antennas (e.g., 2 of the antennas transmit and 4 of the antennas receive (2T4R)). Other quantities may be used based on circuitry (e.g., in FIGS. 3-4) of a respective user equipment. Indeed, the electronic device 10 may determine one or more antennas 55 to use to transmit an SRS, such as at process block 222 of FIG. 8 and/or at process block 152 of FIG. 6. In some systems, the electronic device 10 includes more antenna circuitry than the one or more antennas 55, so the electronic device 10 may at these process blocks 152, 190 select a subset of antennas 55 to use to transmit the SRS. The electronic device 10 may determine the one or more antennas 55 from the antenna circuitry based on which antennas 55 correspond to a relatively greatest transmit power level (e.g., MTPL).

Sometimes both MTPL and reference signal received power (RSRP) are considered as selection metrics to use when selecting the antennas 55 to transmit the SRS. The RSRP may correspond to a power of a received signal from the base station 104 when the electronic device 10 detect the cell at process block 212. When the RSRP is received by multiple antenna 55, the RSRP may indicate transmission path losses that may differ between those antennas 55. However, the electronic device 10 may determine the antennas 55 for the SMDL mode based on MTPL decided per-TX antenna combination, as opposed to per-port, and the MTPL of a TX antenna combination may result in a relatively close metric between pairs of antennas 55. However, when considering the selection for the SMSL mode, MTPL for different transmitting ports may be relatively variable (e.g., quite different, non-negligibly different). This may cause reduced power levels of transmitted signals when the electronic device 10 and the base station 104 exchange user data (e.g., operations of process block 210) relative to power levels that may have been expected by the electronic device 10 based on the MTPL, RSRP, or other selection criteria.

With this in mind, FIGS. 18-22 may describe systems and methods (e.g., adaptive MTPL consideration) that may improve antenna 55 subset determination operations of process blocks 190 and 222 and/or mode confirmation operations of process block 240 herein. For example, the electronic device 10 applying adaptive MTPL consideration systems and methods of FIGS. 18-22 may select the subset of antennas 55 to communicate the SRS based on MTPL that is considered separately for SMDL mode, SMSL mode, and for the different antennas 55 as respectively connected to corresponding power amplifiers 66. Considering these modes and antenna 55 pathways separately may reduce variations between selected channels in SMDL mode and SMSL mode, which may increase the power level used to communicate when exchanging user data (e.g., operations of process block 210). Furthermore, improving these determination operations may enable the electronic device 10 to more accurately determine expected power levels of the network 102 communications based on MTPL, RSRP, or other selection criteria.

To elaborate, FIG. 18 is a flowchart of a method 463 that may be performed to initialize MIMO communications based on the electronic device 10 based on adaptive MTPL operations, according to embodiments of the present disclosure. Any suitable device (e.g., a controller) that may control components of the electronic device 10, such as the processor 12A, may perform the method 463. In some embodiments, the method 463 may be implemented by executing instructions stored in a tangible, non-transitory, computer-readable medium, such as the memory 14 or storage 16, using the processor 12A. For example, the method 463 may be performed at least in part by one or more software components, such as an operating system of the electronic device 10, one or more software applications of the electronic device 10, and the like. While the method 463 is described using steps in a specific sequence, it should be understood that the present disclosure contemplates that the described steps may be performed in different sequences than the sequence illustrated, and certain described steps may be skipped or not performed altogether.

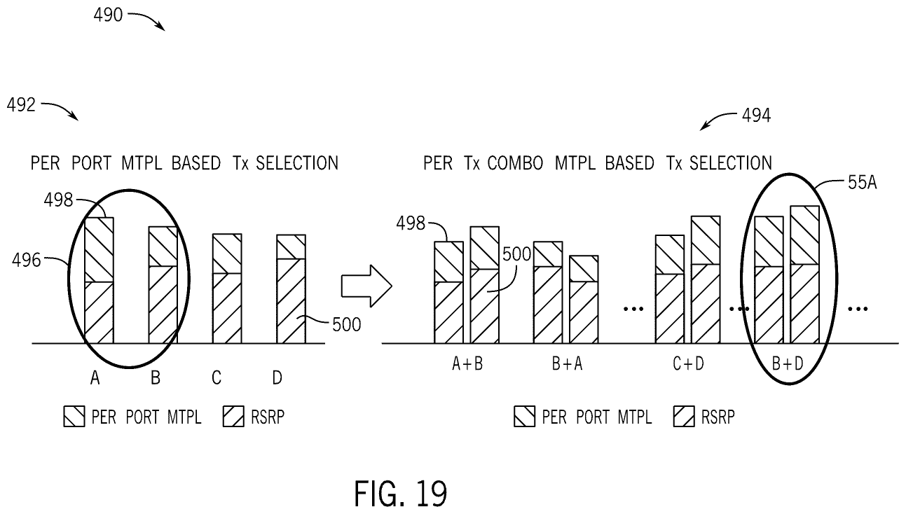

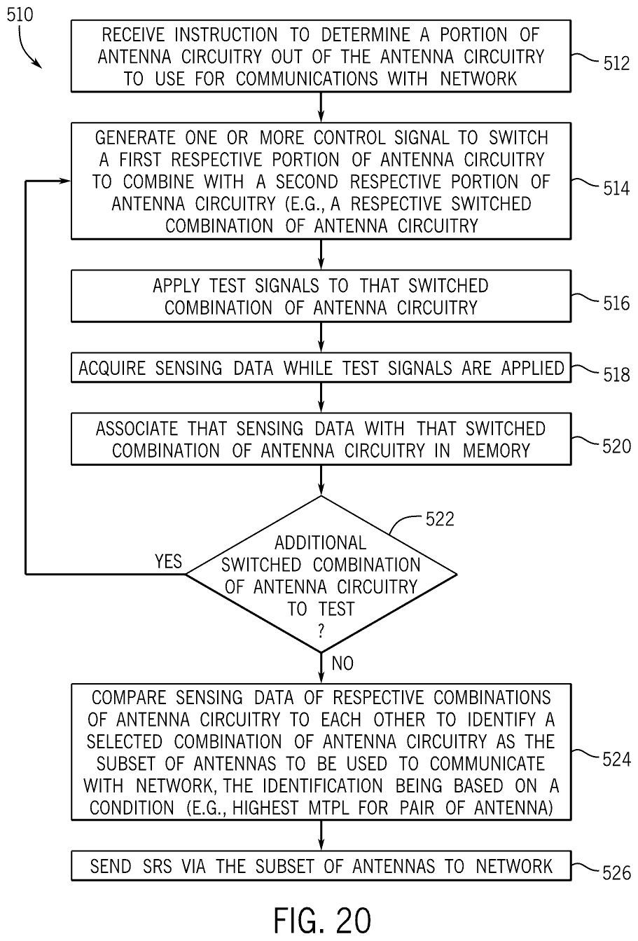

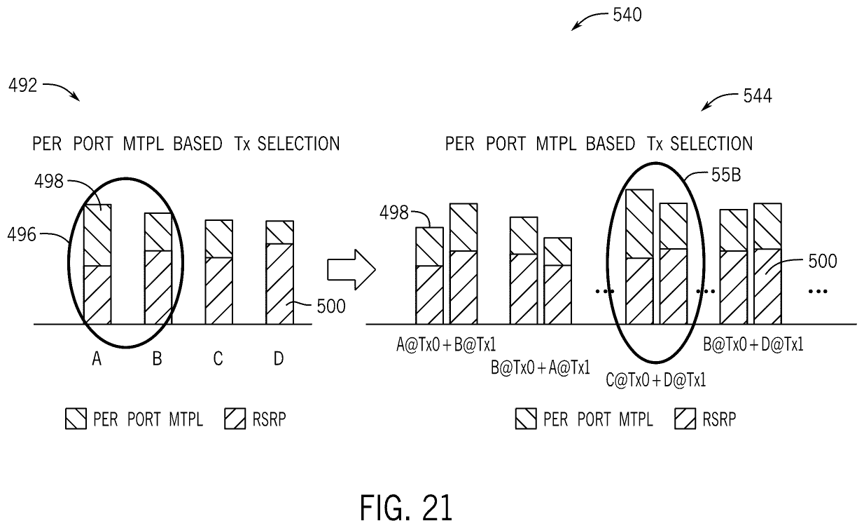

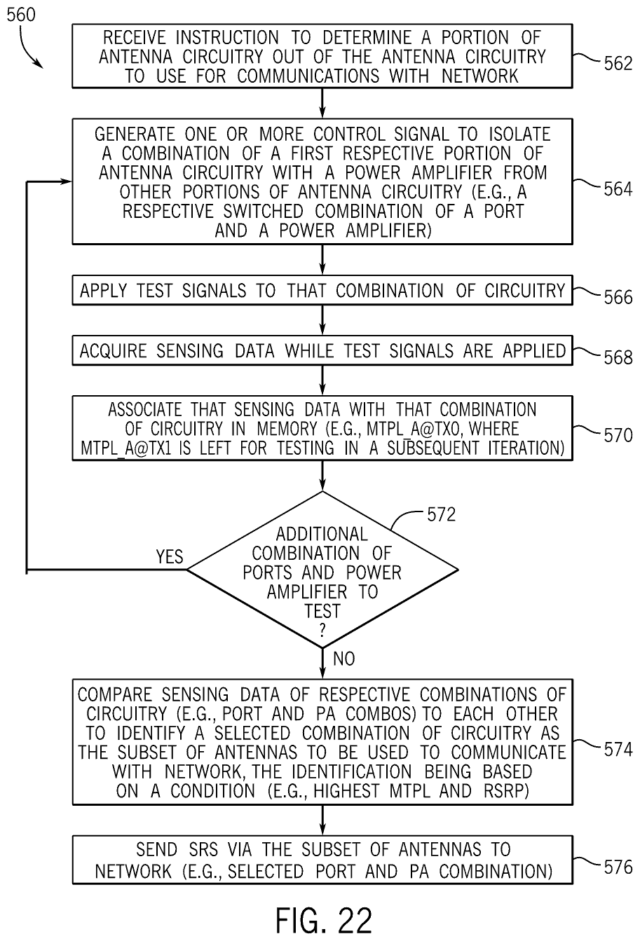

At process block 464, the electronic device 10 receives an instruction to determine a subset of antennas (e.g., 2) from multiple antennas (e.g., 4). At process block 465, the electronic device 10 receives an indication of a maximum power to be used to send SRS signal (e.g., TX power max indication), which may be referred to as a maximum transmit power level (MTPL) associated with one or more antennas 55. At process block 466, the electronic device 10 determines whether the indication of the maximum power to be used to send SRS signal (e.g., TX power max indication) crosses a threshold. In response to determining that the indication crosses the threshold, at process block 468, the electronic device 10 selects the subset of antennas 55 without considering MTPL (e.g., TX power max is capped). In response to determining that the indication does not cross the threshold, at process block 470, the electronic device 10 identifies a dominant mode corresponding to the network selection and/or the UE preference. For SMSL and SMDL mixed scenarios, the electronic device 10 may identity the mode (e.g., SMSL mode or SMDL mode) based on which mode has a percentage of use for that mixed scenario. At process block 472, the electronic device 10 determines whether the SMDL mode is the dominant mode. In response to determining that SMDL mode is the dominant mode, at process block 474, the electronic device 10 selects the subset of antennas based on MTPL per-TX antenna 55 combination (e.g., pair of antennas 55). These operations may correspond to FIGS. 19-20. However, in response to determining that SMSL mode is the dominant mode (e.g., SMDL mode is not the dominant mode), at process block 476, the electronic device 10 selects the subset of antennas 55 based on MTPL per-TX antenna 55 and per-power amplifier 66. These operations may correspond to FIGS. 21-22. From process block 468, process block 476, or process block 474, at process block 478, the user equipment sends the SRS via the subset of antennas to the base station 104, which may correspond to operations of process blocks 190 and 222 of FIG. 8 and thus the method 220 of FIG. 8 may continue.

To elaborate on selecting the subset of antennas based on MTPL per-TX antenna 55 combination, FIG. 19 is a diagrammatic representation 490 of operations of FIG. 18 at process block 474 corresponding to selecting the subset of antennas 55 based on MTPL per-TX antenna 55 combination (e.g., pair of antennas 55), according to embodiments of the present disclosure. When transmit power (TX power) is not capped, the electronic device 10 may not consider MTPL into account when selecting the TX antennas. As noted above, when TX power is capped by a threshold (e.g., operations of 466 of FIG. 18), the electronic device 10 may jointly consider MTPL and RSRP/PL for MIMO OL transmit (TX) antennas selection to select a subset of antennas 55A. The electronic device 10 may do so based on a TX antenna selection of a subset of antennas (e.g., 2 from 4 antennas) adaptively for SMDL mode and SMSL mode. In the SMDL mode (e.g., near or middle cell coverage), the electronic device 10 may consider MTPL per-TX antenna 55 combination (e.g., inset plot 494) as opposed to MTPL per-port for OL TX antenna selection (e.g., inset plot 492), which may yield an antenna selection that is relatively less desired than considering both RSRP and MTPL for the SMDL mode. In this way, the electronic device 10 may select a combination of TX antennas (first antenna, second antenna) with the best combination of RSRP and MTPL. For example, the electronic device 10 may consider a sum of a RSRP of the first antenna 55, RSRP of the second antenna 55, and the MTPL relative to both the first antenna 55 and the second antenna 55 and may determine that subset of antennas 55A is relatively more suitable for the MIMO communication configuration than subset of antennas 496.

In inset plot 492, MTPL 498 and RSRP 500 for each antenna A, B, C, D is illustrated. In inset plot 494, MTPL 498 and RSRP 500 for each pair of antenna A+B, B+A, C+D, . . . B+D is illustrated. For 4 antennas, there may be 16 possible combinations, and the electronic device 10 may determine MTPL 498 and RSRP 500 combinations for each of the combinations.

Indeed, each pair of antennas 55 option may be tested. To elaborate, FIG. 20 is a flowchart of a method 510 corresponding to the operations of FIG. 19 to select the subset of antennas based on MTPL per-TX antenna 55 combination, according to embodiments of the present disclosure. Any suitable device (e.g., a controller) that may control components of the electronic device 10, such as the processor 12A, may perform the method 463. In some embodiments, the method 463 may be implemented by executing instructions stored in a tangible, non-transitory, computer-readable medium, such as the memory 14 or storage 16, using the processor 12A. For example, the method 463 may be performed at least in part by one or more software components, such as an operating system of the electronic device 10, one or more software applications of the electronic device 10, and the like. While the method 463 is described using steps in a specific sequence, it should be understood that the present disclosure contemplates that the described steps may be performed in different sequences than the sequence illustrated, and certain described steps may be skipped or not performed altogether.

The electronic device 10 may test one or more pairs of antennas 55 to determine which subset of antennas to use at process block 190. At process block 512, the electronic device 10 receives an instruction to determine one or more antennas 55 (e.g., a portion of antenna circuitry out of the antenna circuitry) to use for communications with the base station 104. At process block 514, the electronic device 10 generates one or more control signal to switch a first respective portion of antenna circuitry to combine with a second respective portion of antenna circuitry (e.g., a respective switched combination of antennas 55). At process block 516, the electronic device 10 applies one or more test signals to the switched combination of antenna circuitry. At process block 518, the user equipment acquires sensing data while the test signals are applied. The sensing data may correspond to data to be used to determine the RSRP and/or MTPL. At process block 520, the electronic device 10 associates that sensing data with that switched combination of antenna circuitry in memory 14. At process block 522, the electronic device 10 determines whether there is an additional switched combination of antennas 55 to be tested. In response to an additional combination of antennas 55 remaining to be tested, at process block 514, the electronic device 10 may repeat testing of a respective combination of antennas 55. If, at process block 522, the electronic device 10 determines that there is not a remaining combination of antennas 55 to be tested, at process block 524, the electronic device 10 compares sensing data of respective combinations of antenna circuitry to each other to identify a selected combination of antenna circuitry as the subset of antennas 55 to be used to communicate with network, the identification being based on a condition (e.g., highest MTPL for pair of antennas 55). In this way, the electronic device 10 may select a combination of TX antennas 55 (e.g., first antenna 55 and second antenna 55) with the best combination of RSRP and MTPL. For example, the electronic device 10 may consider a sum of a RSRP of the first antenna 55, RSRP of the second antenna, and the MTPL relative to both the first antenna 55 and the second antenna 55. At process block 526, the electronic device 10 may use the selected subset of antennas 55 to transmit the SRS, such as like what is performed at process block 190.

To elaborate on selecting the subset of antennas 55 based on MTPL per-TX antenna 55 per-power amplifier 66, FIG. 21 is a diagrammatic representation 540 of operations of FIG. 18 at process block 476 corresponding to selecting the subset of antennas 55 based on MTPL per-TX antenna 55 per-power amplifier 66, according to embodiments of the present disclosure. When transmit power (TX power) is not capped, the electronic device 10 may not consider MTPL into account when selecting the TX antennas at process block 190. As noted above, when TX power is capped by a threshold (e.g., operations of 466 of FIG. 18), the electronic device 10 may jointly consider MTPL and RSRP/PL for MIMO OL transmit (TX) antennas selection to select a subset of antennas 55A. The electronic device 10 may do so based on a TX antenna selection of a subset of antennas (e.g., 2 from 4 antennas) adaptively for SMDL mode and SMSL mode. When the SMDL mode is the dominant mode (e.g., near or middle cell coverage), the electronic device 10 may consider MTPL per-TX antenna 55 combination, which was described with reference to FIGS. 19-20. When the SMSL mode is the dominant mode (e.g., far cell coverage), the electronic device 10 may consider MTPL per-port per-power amplifier 66 (e.g., inset plot 544) as opposed to MTPL per-TX antenna 55 combination for OL TX antenna selection (e.g., inset plot 492). For each port, the electronic device 10 may also consider MTPL from both first port (Tx0) and second port (Tx1) corresponding power amplifiers 66 (e.g., MTPL_A@Tx0 and MTPL_A@Tx1). The electronic device 10 may select a combination of TX antennas (first antenna, second antenna) (e.g., subset of antennas 55B) with the best combination of RSRP and MTPL. For example, the electronic device 10 may consider a sum of a RSRP of the first antenna, RSRP of the second antenna, MTPL of the first port for the first antenna (e.g., MTPL_A@Tx0), and the MTPL of the second port for the second antenna (e.g., MTPL_B@Tx1) and determine that subset of antennas 55A is relatively more suitable for the MIMO communication configuration than subset of antennas 496.

In inset plot 492, MTPL 498 and RSRP 500 for each antenna A, B, C, D is illustrated. In inset plot 544, MTPL 498 and RSRP 500 for each pair of antennas 55 and each port combination A@Tx0+B@Tx1. B@Tx0+A@Tx1, C@Tx0+D@Tx1, . . . B@Tx0+D@Tx1 is illustrated. For 4 antennas 55 and 4 ports, there may be 16 possible combinations, and the electronic device 10 may determine MTPL 498 and RSRP 500 combinations for each of the 16 combinations.

FIG. 22 is a flowchart of a method 560 corresponding to the operations of FIG. 21 to select the subset of antennas based on MTPL per-TX antenna 55 combination per-power amplifier 66, according to embodiments of the present disclosure. Any suitable device (e.g., a controller) that may control components of the electronic device 10, such as the processor 12A, may perform the method 560. In some embodiments, the method 560 may be implemented by executing instructions stored in a tangible, non-transitory, computer-readable medium, such as the memory 14 or storage 16, using the processor 12A. For example, the method 560 may be performed at least in part by one or more software components, such as an operating system of the electronic device 10, one or more software applications of the electronic device 10, and the like. While the method 560 is described using steps in a specific sequence, it should be understood that the present disclosure contemplates that the described steps may be performed in different sequences than the sequence illustrated, and certain described steps may be skipped or not performed altogether.

The electronic device 10 may test one or more pairs of antennas 55 to determine which subset of antennas to use at process block 190. At process block 562, the electronic device 10 receives an instruction to determine one or more antennas 55 (e.g., a portion of antenna circuitry out of the antenna circuitry) to use for communications with the base station 104. At process block 564, the electronic device 10 generates one or more control signal to isolate a combination of a first respective portion of antenna circuitry with a power amplifier 66 from other portions of antenna circuitry (e.g., a respective switched combination of a port and a power amplifier 66). At process block 566, the electronic device 10 applies one or more test signals to the switched combination of antenna circuitry. At process block 568, the user equipment acquires sensing data while the test signals are applied. The sensing data may correspond to data to be used to determine the RSRP and/or MTPL. At process block 570, the electronic device 10 associates that sensing data with that combination of circuitry in memory (e.g., MTPL_A@Tx0, where MTPL_A@Tx1 is left for testing in a subsequent iteration). At process block 572, the electronic device 10 determines whether there is an additional combination of antennas 55 and ports to be tested. In response to an additional combination of antennas 55 remaining to be tested, at process block 564, the electronic device 10 may repeat testing of a respective combination of antennas 55 and ports. If, at process block 572, the electronic device 10 determines that there is not a remaining combination of antennas 55 and ports to be tested, at process block 574, the electronic device 10 compares sensing data of respective combinations of circuitry (e.g., port and PA combos) to each other to identify a selected combination of circuitry as the subset of antennas to be used to communicate with network, the identification being based on a condition (e.g., highest MTPL and RSRP). In this way, the electronic device 10 may select a combination of TX antennas 55 (e.g., first antenna 55 and second antenna 55) with the best combination of RSRP and MTPL. For example, the electronic device 10 may consider a sum of a RSRP of the first antenna, RSRP of the second antenna, MTPL of the first port for the first antenna (e.g., MTPL_A@Tx0), and the MTPL of the second port for the second antenna (e.g., MTPL_B@Tx1). At process block 576, the electronic device 10 may use the selected subset of antennas 55 to transmit the SRS, such as like what is performed at process block 190.

In some open loop TX antenna combination selection operations, the electronic device 10 may be constrained to selecting antennas 55 from different hemispheres as a pair. The same hemisphere TX antenna combination blocking may be dynamic, enabled for a single layer transmission mode (e.g., SMSL mode) and disabled for dual layer transmission mode (e.g., SMDL mode). This dynamic change may be based on RSRP and whether the network 102 assigned the SMSL mode or SMDL mode.

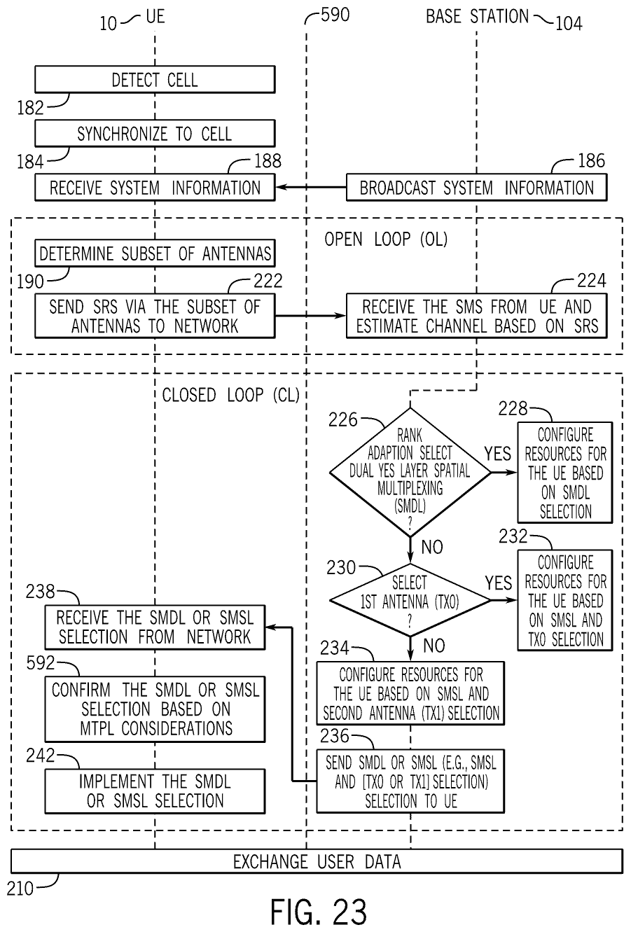

Keeping the foregoing mind, sometimes confirmation operations of FIG. 8 of process block 240 occur based on MTPL considerations as opposed to sounding operations. To help illustrate, FIG. 23 is a flowchart of a method 590 corresponding to the method 220 of FIG. 8 that may be performed to initialize the MIMO communications based on confirming the selected number of data layers using MTPL considerations associated with the closed loop operations, according to embodiments of the present disclosure. Any suitable device (e.g., a controller) that may control components of the electronic devices, such as the processor 12A, may perform some of the method 590. Some of the method 590 may be performed by electronic device 10 via processors 12A and some of the method 590 may be performed by electronic devices associated with the network 102, such as the base station 104 via a processor 12B. In some embodiments, the method 590 may be implemented by executing instructions stored in a tangible, non-transitory, computer-readable medium, such as the memory 14 or storage 16, using the processor 12A and by executing instructions stored in a tangible, non-transitory, computer-readable medium, such as the memory 14 or storage 16, using the processor 12B. For example, the method 590 may be performed at least in part by one or more software components, such as an operating system of the electronic device 10, one or more software applications of the electronic device 10, and the like. While the method 590 is described using steps in a specific sequence, it should be understood that the present disclosure contemplates that the described steps may be performed in different sequences than the sequence illustrated, and certain described steps may be skipped or not performed altogether.

Since one or more process blocks overlap with those included in FIG. 8, these descriptions are relied upon herein. The method 590 includes a process block 592, at which the electronic device 10 confirms the SMDL or SMSL selection from the base station 104 (e.g., received at process block 238) based on MTPL considerations. MTPL considerations may correspond to power levels resulting in TX signals from one or more antennas 55. In some cases, the MTPL considerations include transmission losses that change a power of a transmit signal in route to the antenna 55 from the power amplifier 66. The electronic device 10 may change the SMDL or SMSL selection of port and antennas if the electronic device 10 determines that a more efficient transmission pathway is present.

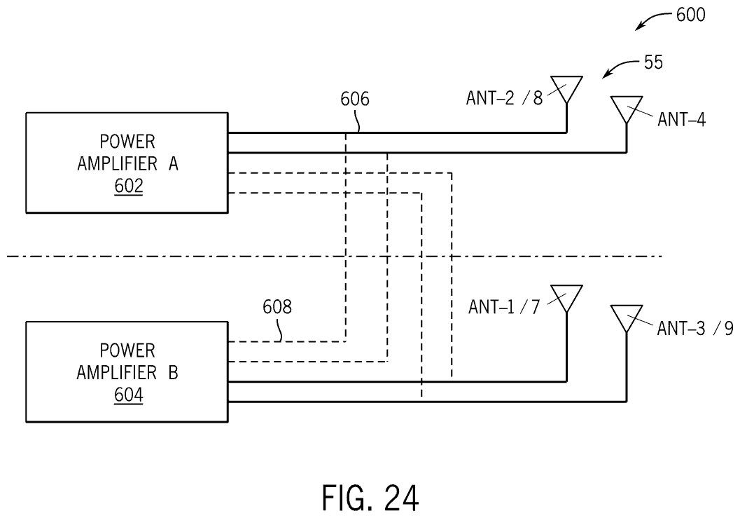

To elaborate, FIG. 24 is a diagrammatic representation of one or more power amplifiers 66 (PA) and one or more antennas 55 to illustrate an example of how PA-to-port transmission pathways may affect power of transmitting signals, and thus be an example of the MTPL considerations of FIG. 23, according to embodiments of the present disclosure. In this example, a power amplifier 602 and a power amplifier 604 may be used in a 2 TX antenna mode. Different power amplifiers (e.g., power amplifiers 66, 602, 604) connected to different antennas 55 may have different power limits and/or TX power levels. This may be due to differences in transmission line losses associated with sensing the TX signal from the power amplifier 66 to the antenna 55. For example, the power amplifier 602 and the power amplifier 604 may each generate a respective TX signal having a same power level. The power amplifier 602 may be coupled to the antenna 55 “Ant-2/8.” The power amplifier 604 may be coupled to the antenna 55 “Ant-4.” A TX signal from the antenna 55 “Ant-2/8” may have a relatively higher power level since the path 606 is shorter than path 608, which reduces transmission power losses.

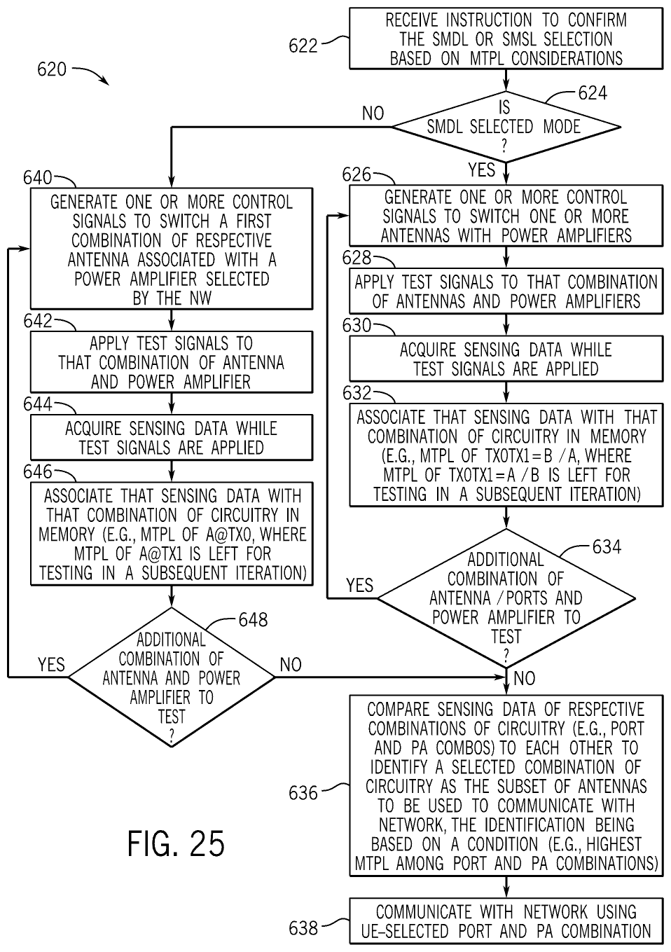

FIG. 25 is a flowchart of a method 620 that may be performed to confirm the network-selected number of data layers (e.g., SMSL mode or SMDL mode) using the MTPL considerations of FIGS. 23-24, according to embodiments of the present disclosure. Any suitable device (e.g., a controller) that may control components of the electronic device 10, such as the processor 12A, may perform the method 620. In some embodiments, the method 620 may be implemented by executing instructions stored in a tangible, non-transitory, computer-readable medium, such as the memory 14 or storage 16, using the processor 12A. For example, the method 620 may be performed at least in part by one or more software components, such as an operating system of the electronic device 10, one or more software applications of the electronic device 10, and the like. While the method 620 is described using steps in a specific sequence, it should be understood that the present disclosure contemplates that the described steps may be performed in different sequences than the sequence illustrated, and certain described steps may be skipped or not performed altogether.

At process block 622, the electronic device 10 receives instruction to confirm the network-selection of data layers (e.g., the SMDL mode or SMSL mode selection) based on MTPL considerations discussed herein (e.g., FIGS. 23-27). The instruction may be read from the memory 14. At process block 624, the electronic device 10 determines whether the network-selected the SMDL mode. The electronic device 10 may do so based on the received indication from the base station 104 at process blocks 236-238 of FIG. 23.

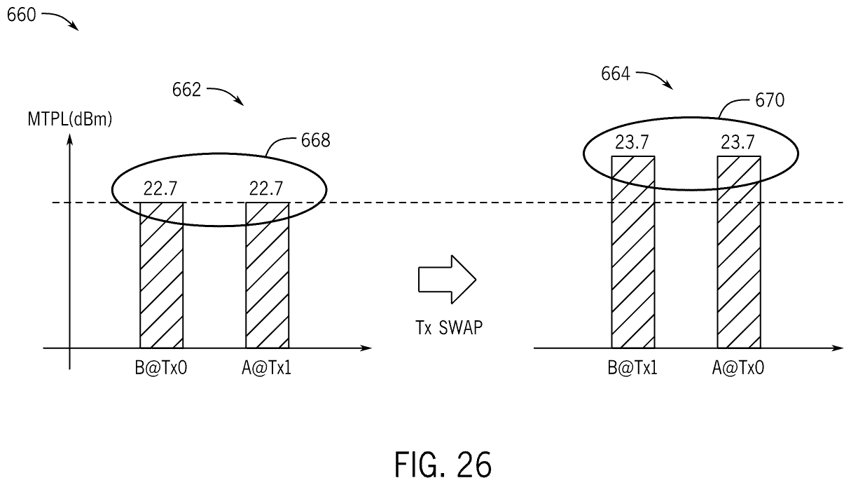

In response to the network 102 selecting the SMDL mode, at process block 626, the electronic device 10 generates one or more control signals to switch one or more antennas 55 with power amplifiers (e.g., power amplifier 602, power amplifier 604, other suitable circuitry of FIG. 3). Operations of process blocks 626-634 may correspond to the plots of FIG. 26.

Referring briefly to FIG. 26, FIG. 26 is a diagrammatic representation 660 of the MTPL considerations of FIGS. 23-25 corresponding to spatial multiplexing dual layer (SMDL), according to embodiments of the present disclosure. Since different antenna 55 connected to different power amplifiers 66 may provide different MTPL levels, the electronic device 10 may select the configuration with a relatively higher MTPL by swapping which antenna 55 are paired with which power amplifier 66 for the MMO communications. When the SMDL mode is selected by the base station 104, the base station 104 may assign a first port Tx0 to a first antenna 55, antenna B, and a second port Tx1 to a second antenna 55, antenna A. (e.g., Tx0Tx1=B/A). The electronic device 10 may calculate the MTPL of the network 102 assignment (e.g., Tx0Tx1=B/A, illustrated via inset plot 662) and the MTPL of a UE-adjusted assignment (e.g., Tx0Tx1=A/B, illustrated via inset plot 664) to determine which of the combinations provides a higher MTPL. The electronic device 10 may swap to the combination that provides the higher MTPL. Here, the UE-adjusted assignment (e.g., Tx0Tx1=A/B, illustrated via inset plot 664) produces a relative greater MTPL 670 than MTPL 668 of the network 102 assignment and thus the electronic device 10 would select the UE-adjusted assignment.

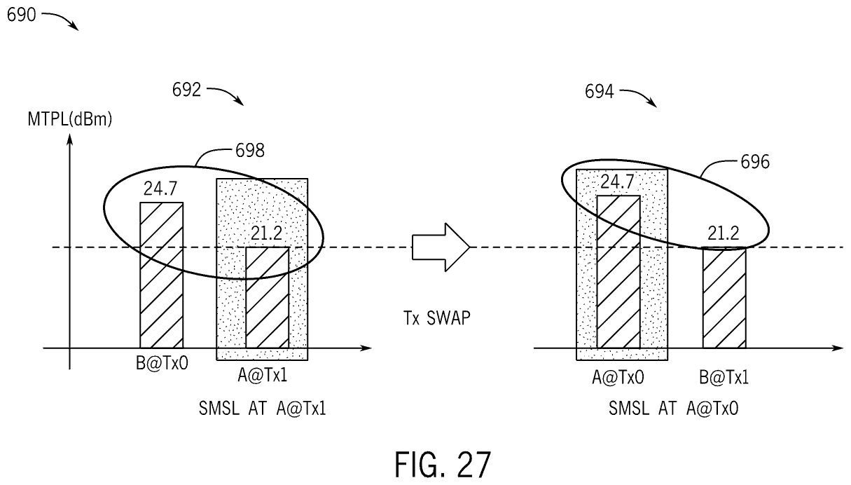

Returning back to FIG. 25, at process block 628, the electronic device 10 applies test signals to that combination of antennas 55 and power amplifiers 66 in response to the SMDL mode being selected by the base station 104. As noted in FIG. 27, the base station 104 may select a communication channel corresponding to a combination of power amplifiers 66 and antennas 55 (e.g., Tx0Tx1=B/A) and the electronic device 10 applies test signals to that combination. At process block 630, the electronic device 10 acquires sensing data while the test signals are applied, where the sensing data corresponds to MTPL of signals transmitted via that power amplifier 66 and antenna 55 combination. At process block 632, the electronic device 10 associates the sensing data with that power amplifier 66 and antenna 55 combination in the memory 14. For example, when the base station 104 selects a combination of power amplifiers 66 and antennas 55 of Tx0Tx1=B/A, the user equipment associates the sensing data indicative of MTPL and an indication of Tx0Tx1=B/A in the memory 14. In this example, the MTPL of Tx0Tx1=A/B is left for testing in a subsequent iteration at process block 634.

At process block 634, the electronic device 10 determines whether an additional combination of antenna 55 and power amplifier 66 are to be tested. The additional combination may arise by swapping the power amplifier 66 and antenna assignment. For example, swapping assignments in the tested combination to identify combination Tx0Tx1=A/B. In response to at least one additional combination of power amplifiers 66 and network-selected antenna 55 to be tested, at process block 626, the electronic device 10 repeats performing operations of process blocks 626-634. As noted in FIG. 27, the base station 104 may select a communication channel corresponding to a port and an antenna 55 combination. To apply test signals, the electronic device 10 test that combination and may at least swap a power amplifier 66 (e.g., port) assigned to that antenna (e.g., antenna A tested against Tx1 and Tx0 by the time that operations end).

In response to determining that no additional combinations remain, at process block 636, the electronic device 10 compares sensing data of respective combinations of circuitry (e.g., Tx0Tx1=B/A and Tx0Tx1=A/B when proceeding from operations of process block 634) to each other to identify the selected combination of circuitry as the subset of antennas to be used to communicate with network. The electronic device 10 proceeds to, at process block 638, the electronic device 10 communicates with the network 102 using the selected antenna 55 and power amplifier 66 combination (e.g., selected via operations of process block 636). This communication may be similar to communications of process block 210 of FIG. 23.

Returning to process block 624, in response to the network 102 selecting the SMSL mode, at process block 640, the electronic device 10 generates one or more control signals to switch a first combination of respective antenna 55 associated with a power amplifier 66 (e.g., power amplifier 602, power amplifier 604, other suitable circuitry of FIG. 3) selected by the network (NW) via the base station 104 or other suitable circuitry of the network 102. Operations of process blocks 626-634 may correspond to the plots of FIG. 27.

Referring briefly to FIG. 27, FIG. 27 is a diagrammatic representation 690 of the MTPL considerations of FIGS. 23-25 corresponding to spatial multiplexing single layer (SMSL), according to embodiments of the present disclosure. Since different antenna 55 connected to different power amplifiers 66 may provide different MTPL levels, the electronic device 10 may select the configuration with a relatively higher MTPL by swapping which antenna 55 are paired with which power amplifier 66 for the MMO communications. When the SMSL mode is selected by the base station 104, the base station 104 may assign a first port Tx0 to a first antenna 55, antenna B, and a second port Tx1 to a second antenna 55, antenna A. (e.g., Tx0Tx1=B/A) and assign SMSL mode using the second antenna 55 and the second port TX1 (e.g., SMSL at A@Tx1). The electronic device 10 may calculate the MTPL of the network 102 assignment (e.g., Tx0Tx1=B/A with SMSL at A@Tx1, illustrated via inset plot 692) and the MTPL of a UE-adjusted assignment (e.g., Tx0Tx1=A/B with SMSL at A@Tx0, illustrated via inset plot 694) to determine which of the combinations provides a higher MTPL. The electronic device 10 may swap to the combination that provides the higher MTPL. Here, the UE-adjusted assignment (e.g., Tx0Tx1=A/B with SMSL at A@Tx0, illustrated via inset plot 694) produces a relative greater MTPL 696 than MTPL 698 of the network 102 assignment and thus the electronic device 10 would select the UE-adjusted assignment. When performing this determination, when the network 102 assigns A@Tx1, the electronic device 10 may calculate MTPL of A@Tx1 and the MTPL of A@Tx0 to implement the assignment with the higher MTPL, and thus may not calculate the MTPL associated with the first antenna 55 each time. When the network 102 assigns B@Tx1, the electronic device 10 may calculate MTPL of B@Tx1 and the MTPL of B@Tx0 to implement the assignment with the higher MTPL, and thus may not calculate the MTPL associated with the second antenna 55 each time.

Returning back to FIG. 25, at process block 642, the electronic device 10 applies test signals to that combination of antennas 55 and power amplifiers 66 in response to the SMSL mode being selected by the base station 104. As noted in FIG. 27, the base station 104 may select a communication channel corresponding to a power amplifier 66 (e.g., Tx #) and an antenna 55 combination. At process block 642, the electronic device 10 applies test signals to that power amplifier 66 and antenna 55 combination. At process block 644, the electronic device 10 acquires sensing data while the test signals are applied, where the sensing data corresponds to MTPL of signals transmitted via that power amplifier 66 and antenna 55 combination. At process block 646, the electronic device 10 associates the sensing data with that power amplifier 66 and antenna 55 combination in the memory 14. For example, when the base station 104 selects an antenna 55 and power amplifier 66 combination A@Tx0, the electronic device 10 may associate the sensing data and an indication of A@Tx0 into memory 14. In this example, the MTPL of A@Tx1 is left for testing in a subsequent iteration at process block 648.

At process block 648, the electronic device 10 determines whether an additional combination of antenna 55 and power amplifier 66 are to be tested. In response to at least one additional combination of power amplifiers 66 and network-selected antenna 55 to be tested, at process block 640, the electronic device 10 repeats performing operations of blocks 640-648. As noted in FIG. 27, the base station 104 may select a communication channel corresponding to a port and an antenna 55 combination. To apply test signals, the electronic device 10 test that combination and may at least swap a power amplifier 66 (e.g., port) assigned to that antenna 55 (e.g., antenna A tested against Tx1 and Tx0 by the time that operations end).

In response to determining that no additional combinations remain, at process block 636, the electronic device 10 compares sensing data of respective combinations of circuitry (e.g., A@Tx1 and A@Tx0 when proceeding from operations of process block 648) to each other to identify the selected combination of circuitry as the subset of antennas 55 to be used to communicate with network. The electronic device 10 proceeds to, at process block 638, the electronic device 10 communicates with the network 102 using the selected antenna 55 and power amplifier 66 combination (e.g., selected via operations of process block 636). This communication may be similar to communications of process block 210 of FIG. 23.

Performing methods of FIGS. 23-27 may enable the electronic device 10 to transmit signals with relatively greater power levels by selecting transmission pathway combinations that cause reduced amounts of power loss when transmitting the signal via the antenna circuitry. It is noted that via the operations of method 620, the electronic device 10 may adjust the MIMO communication mode without notifying the base station 104 of the change, which may enable relatively faster implementation of the change. The electronic device 10 may do so since a same communication channel selected by the base station 104 may remain selected and what changes is the UE-side assignment of antennas 55 and power amplifiers 66, 602, 604 to communicate via the selected communication channel.

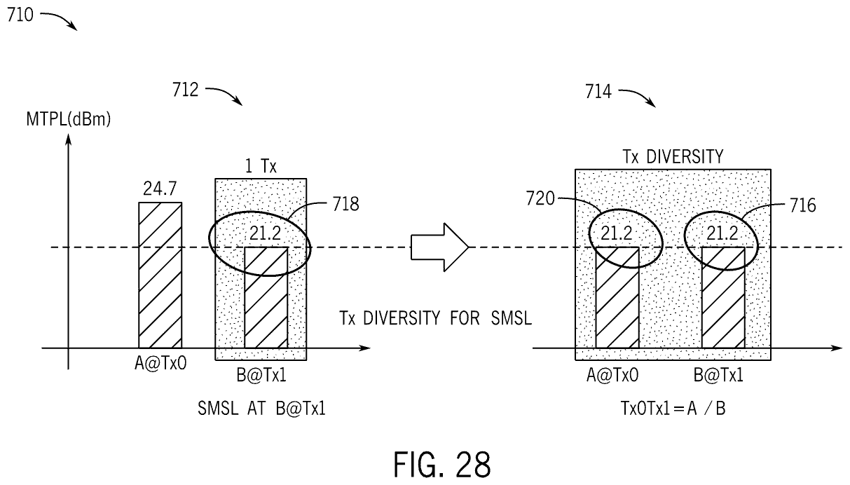

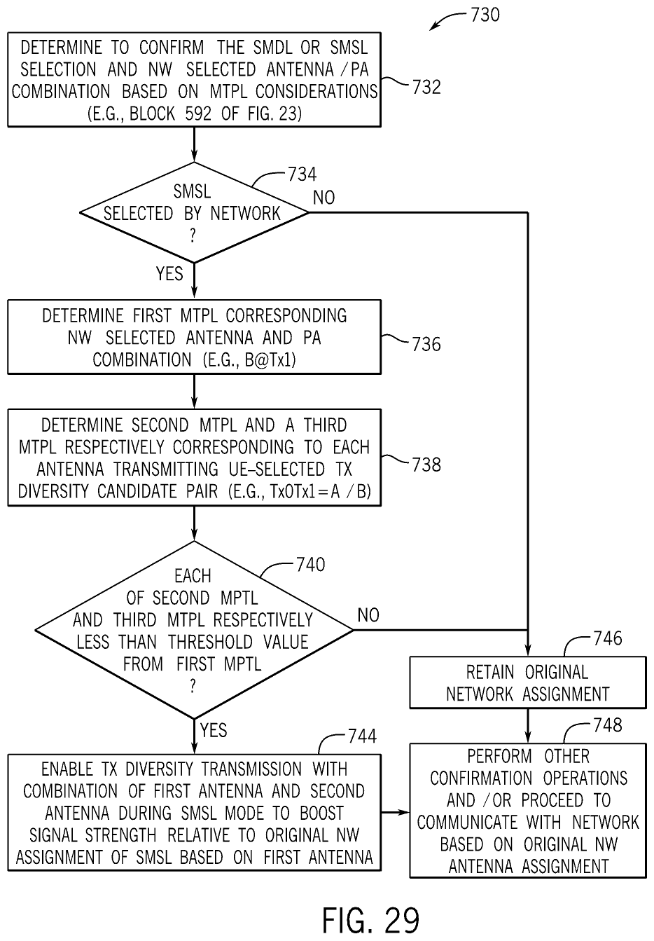

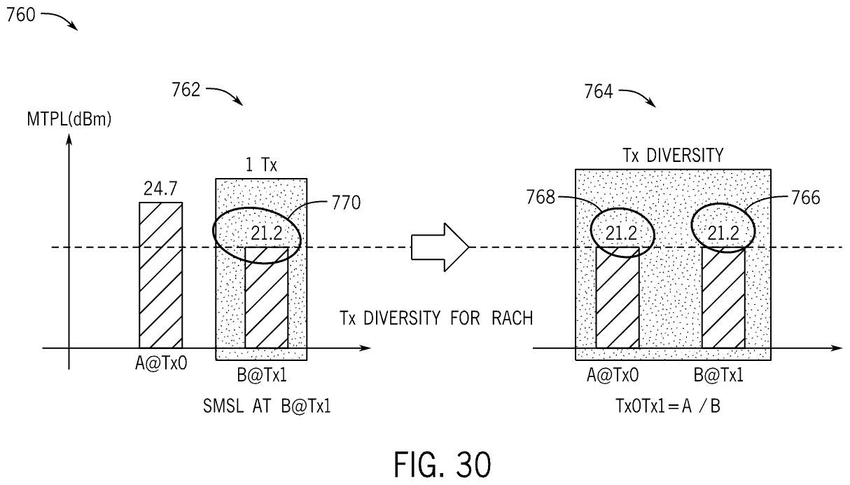

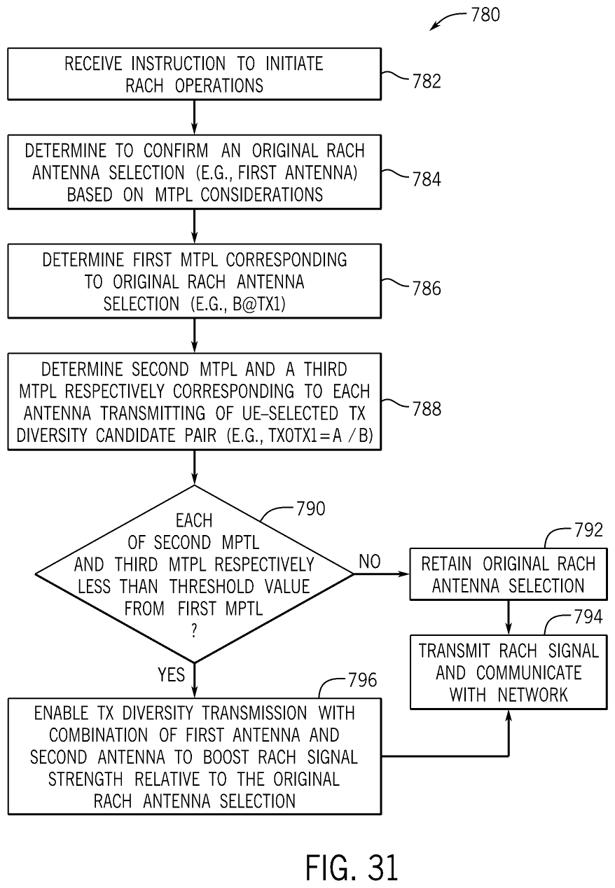

Keeping the foregoing in mind, the electronic device 10 and the network 102 may sometimes experience communication situations in which transmit signals with higher power levels may be desired. For example, the electronic device 10 may be at a further distance from the base station 104 and may want to selectively boost the power of transmit signals to arrive at the base station 104 undistorted. Other examples may exist where selective signal strength may be desired, such as when environmental changes occur, when an interfering body is between the electronic device 10 and the base station 104 (e.g., partial or complete material blockage), the electronic device 10 is in a bag, in a building, or the like. FIGS. 28-31 correspond to example systems and methods that may enable the electronic device 10 to implement selective signal strength. In some cases, TX signal boosting methods of FIGS. 28-31 may be applied to sending the SRS at process block 222 of FIG. 23. For purposes of discussion, user data exchange communications and RACH signal communications are specifically described by FIGS. 28-31. Indeed. FIGS. 28 and 29 correspond to boosting SMSL mode signals by transmitting via two or antennas despite one antenna 44 being assigned to the communication. Furthermore, FIGS. 30 and 31 correspond to boosting RACH signals by transmitting via two or antennas.

To elaborate, FIG. 28 is a diagrammatic representation 710 of a method (e.g., of FIG. 29) that may be performed by the user equipment of FIG. 1 to enable transmission diversity while in a connected mode with the network 102 to boost strength of a transmit signal (e.g., selective signal strength operations), according to embodiments of the present disclosure. Indeed, while in the connected mode, the electronic device 10 may have already synced to the cell of the base station 104 (e.g., operations of process blocks 212-224) and the base station 104 may have already sent a MIMO communication selection (e.g., SMSL mode or SMDL mode and/or indication of communication channel selection) at process block 236 in FIG. 23. When the base station 104 selects the SMSL mode and a first antenna 55, the electronic device 10 may transmit signals with TX diversity despite being assigned the SMSL mode. To do so, the electronic device 10 may identify a second antenna 55 to pair with the first antenna 55 for TX diversity if MTPL of the first antenna 55 is substantially similar to the respective MTPLs of the first and second antennas 55 when simultaneously transmitting. In some cases, the electronic device 10 may switch power amplifiers 66 with the first antenna 55 and second antenna 55, relative to a network assignment, to better align MTPL of the network-selected antenna 55 (e.g., according to methods of FIGS. 24-27).

Inset plot 712 illustrates that the base station 104 selected antenna B with power amplifier 66 Tx1 for the SMSL mode. To transmit with TX diversity, the electronic device 10 (at inset plot 714) determines whether the transmitting combination of antenna B and antenna A (e.g., Tx0Tx1=A/B) produces a MTPL 716 and a MTPL 720 that respectively equal to the MTPL 718 of the antenna B. Thus, since MTPL 720 is substantially equal to MTPL 718, the user equipment identifies the second antenna A to be paired with antenna B to transmit signals with TX diversity. FIG. 29 may outline these associated operations, which may be transparent to the network 102 and the base station 104.

Indeed, FIG. 29 is a flowchart of a method 730, which may correspond to operations of the process block 592 from the method 590 of FIG. 23 that may be performed to initialize the MIMO communications based on confirming network 102 selections using MTPL considerations described in FIG. 28, according to embodiments of the present disclosure. Any suitable device (e.g., a controller) that may control components of the electronic device 10, such as the processor 12A, may perform the method 730. In some embodiments, the method 730 may be implemented by executing instructions stored in a tangible, non-transitory, computer-readable medium, such as the memory 14 or storage 16, using the processor 12A. For example, the method 730 may be performed at least in part by one or more software components, such as an operating system of the electronic device 10, one or more software applications of the electronic device 10, and the like. While the method 730 is described using steps in a specific sequence, it should be understood that the present disclosure contemplates that the described steps may be performed in different sequences than the sequence illustrated, and certain described steps may be skipped or not performed altogether.

To start the method 730, the electronic device 10 determines to confirm MIMO communication configuration received from the base station 104. Indeed, at process block 732, the electronic device 10 determines to confirm a SMDL mode or SMSL mode selection from the base station 104 based on MTPL considerations (e.g., of FIG. 28). The electronic device 10 may use the method 730 to confirm the MIMO communication configuration, which includes the SMDL or SMSL selection, from the base station 104. These operations may be similar to confirmation operations of process block 592 of FIG. 23, and thus description may be relied on herein. However, it is noted that MTPL considerations corresponding to FIG. 28 are considered via process block 732.

At process block 734, the electronic device 10 determines whether SMSL mode was selected by the network 102 via the base station 104. In response to determining that SMDL mode was selected, at process block 746, the electronic device 10 retains the original network 102 antenna 55 assignments indicated via the MIMO communication configuration. The electronic device 10 may not attempt to transmit with TX signal diversity, and may default to the original network assignments. In some systems, the electronic device 10 may proceed to perform any additional confirmation operations described herein relative to FIGS. 6-27 to confirm the network 102 selection of the SMDL mode.

In response to the electronic device 10 determining that SMSL mode was selected, at process block 736, the electronic device 10 determines a first MTPL corresponding to the network-selected antenna 55 and power amplifier 66 (PA) combination (e.g., B@Tx1). As noted herein, the MIMO communication configuration from the base station 104 may indicate the network-selected antenna 55 and PA selection to the electronic device 10. At process block 738, the electronic device 10 determines a second MTPL and determines a third MTPL. If the network-selected antenna 55 is antenna A, the second MTPL corresponds to the antenna B transmitting at the same time as the antenna A and the third MTPL corresponds to the antenna A transmitting at the same time as the antenna B. Thus, the second MTPL and the third MTPL respectively correspond to each of the transmitting antennas 55 of a UE-selected TX diversity candidate pair (e.g., Tx0Tx1=A/B). MTPL of the network-selected antenna/PA combination may be compared to each MTPL of antennas 55 in the UE-selected TX diversity candidate pair to determine that relative power level matching is expected to occur when substituting SMSL TX diversity transmission for a single antenna SMSL mode. Indeed, at process block 740, the electronic device 10 determines whether each of second MTPL and third MTPL respectively less than threshold value from first MTPL to evaluate whether the various MTPLs are a negligible difference in value (e.g., either greater than or less than) relative to each other. The threshold value may correspond to 1% of the first MTPL, 2% of the first MTPL, 3% of the first MTPL, or any suitable tolerance value. To meet MTPL specifications, a respective MTPL of the TX diversity candidate pair may not be more than the threshold value (e.g., a suitable tolerance value) greater than or less than the first MTPL.

In response to determining that the TX diversity candidate antenna 55 pair does not meet MTPL specifications, the electronic device 10, at process block 746, retains original network 102 assignment for SMSL (e.g., original antenna 55 and power amplifier 66 assignment). In response to determining that one or both of the second MTPL and third MTPL is at least the threshold value different from the first MTPL, the user equipment may determine that the TX diversity candidate antenna 55 pair not meet MTPL specifications. Thus, at process block 746, the user equipment may retain the original network 102 assignment and perform other operations described herein for process block 746 and/or process block 748.

However, in response to determining that one or both of the second MTPL and third MTPL are less than the threshold value different from the first MTPL, the user equipment may determine that the TX diversity candidate antenna 55 pair meets MTPL specifications. Thus, at process block 744, the electronic device 10 enables TX diversity transmission using the combination of first antenna 55 and second antenna 55 during the SMSL mode to boost signal strength relative to original NW assignment of SMSL based on first antenna 55. At process block 748 from the process blocks 744 or 746, the electronic device 10 performs other confirmation operations and/or proceeds to communicate with network 102 based on the antenna assignment from whichever of process block 744 or 746 the operation at process block 748 was preceded.

Similar to systems and methods of FIGS. 28 and 29, FIG. 30 is a diagrammatic representation 760 of a method (e.g., of FIG. 31) that may be performed by the electronic device 10 to enable transmission diversity while in an idle mode with the network 102 to boost strength of a transmit Random Access Channel (RACH) signal (e.g., selective signal strength operations), according to embodiments of the present disclosure.

Indeed, while in the idle mode, the electronic device 10 may have be not actively communicating with the network 102. The electronic device 10 may transmit a RACH signal to the base station 104 begin communications with the network 102. The electronic device 10 may use an uplink MIMO capability with its idle mode RACH channel. When RACH is triggered, the electronic device 10 may receive a first antenna 55 selection, either by default (e.g., from a setting in memory 14) or from the network 102 via the base station 104. However, the electronic device 10 may confirm the first antenna 55 selection and determine whether to transmit its RACH signal with TX diversity. Indeed, the electronic device 10 may transmit signals with TX diversity despite a SMSL mode selection. To do so, the electronic device 10 may identify a second antenna 55 to pair with the first antenna 55 for TX diversity (e.g., TX diversity pair candidate) if MTPL of the first antenna 55 is substantially similar to the respective MTPLs of the first and second antennas 55 when simultaneously transmitting. In some cases, the electronic device 10 may switch power amplifiers 66 with the first antenna 55 and second antenna 55, relative to a network assignment, to better align MTPL of the combination of antennas 55 with the MTPL of the network-selected antenna 55 (e.g., according to methods of FIGS. 24-27).

Inset plot 762 illustrates that the base station 104 selected antenna B with power amplifier 66 Tx1 for the SMSL mode (e.g., SMSL at B@Tx1). To transmit RACH with TX diversity, the electronic device 10 (at inset plot 764) determines whether the transmitting combination of antenna B and antenna A (e.g., Tx0Tx1=A/B) produces a MTPL 766 and a MTPL 768 that respectively equal to MTPL 770 of the antenna B. Thus, since MTPL 768 is substantially equal to MTPL 770, the electronic device 10 identifies the antenna A to be paired with the antenna B to transmit RACH with TX diversity. FIG. 21 may outline these associated operations, which may be transparent to the network 102 and the base station 104.

FIG. 31 is a flowchart of method 780 associated with FIG. 30 that may be applied to determining whether to transmit RACH with TX diversity, according to embodiments of the present disclosure. Any suitable device (e.g., a controller) that may control components of the electronic device 10, such as the processor 12A, may perform the method 780. In some embodiments, the method 780 may be implemented by executing instructions stored in a tangible, non-transitory, computer-readable medium, such as the memory 14 or storage 16, using the processor 12A. For example, the method 780 may be performed at least in part by one or more software components, such as an operating system of the electronic device 10, one or more software applications of the electronic device 10, and the like. While the method 780 is described using steps in a specific sequence, it should be understood that the present disclosure contemplates that the described steps may be performed in different sequences than the sequence illustrated, and certain described steps may be skipped or not performed altogether.

At process block 782, the electronic device 10 receives an instruction to initiate RACH operations, where the instruction may indicate to do so based on MTPL considerations (e.g., of FIG. 30). At process block 784, the electronic device 10 determines to confirm an original antenna selection associated with the RACH operations (e.g., first antenna) based on the MTPL considerations.

At process block 786, the electronic device 10 determines a first MTPL corresponding to the network-selected antenna B and power amplifier 66 (PA) combination (e.g., B@Tx1). In the example of FIG. 30, the first MTPL corresponds to MTPL 770. At process block 788, the electronic device 10 determines a second MTPL and a third MTPL. If the network-selected antenna is antenna B, the second MTPL corresponds to the antenna A transmitting at the same time as the antenna B and the third MTPL corresponds to the antenna B transmitting at the same time as the antenna A. Thus, the second MTPL and the third MTPL respectively correspond to each of the transmitting antennas of a UE-selected TX diversity candidate pair (e.g., Tx0Tx1=A/B). In the example of FIG. 30, the second MTPL corresponds to MTPL 768 and the third MTPL corresponds to MTPL 766. MTPL of the network-selected antenna/PA combination may be compared to each MTPL of antennas in the UE-selected TX diversity candidate pair to determine that relative power level matching is expected to occur when substituting RACH TX diversity transmission for a single antenna RACH transmission. Indeed, at process block 790, the electronic device 10 determines whether each of second MTPL and third MTPL respectively less than threshold value from first MTPL to evaluate whether the various MTPLs are a negligible difference in value (e.g., either greater than or less than) relative to each other. The threshold value may correspond to 1% of the first MTPL, 2% of the first MTPL, 3% of the first MTPL, or any suitable tolerance value. To meet MTPL specifications, a respective MTPL of the TX diversity candidate pair may not be more than the threshold value (e.g., a suitable tolerance value) greater than or less than the first MTPL.

In response to determining that the TX diversity candidate antenna 55 pair does not meet MTPL specifications, the electronic device 10, at process block 792, retains original network assignment for SMSL (e.g., original antenna 55 and power amplifier 66 assignment). In response to determining that one or both of the second MTPL and third MTPL is at least the threshold value different from the first MTPL, the user equipment may determine that the TX diversity candidate antenna 55 pair not meet MTPL specifications. Thus, at process block 792, the user equipment may retain the original network 102 assignment and perform other operations described herein for process block 792 and/or process block 794. The electronic device 10 may not attempt to transmit RACH with TX signal diversity, and may default to the original assignments. In some systems, the electronic device 10 may proceed to perform any additional confirmation operations described herein relative to FIGS. 6-27 before transmitting the RACH signal at process block 794.

However, in response to determining that one or both of the second MTPL and third MTPL are less than the threshold value different from the first MTPL, the user equipment may determine that the TX diversity candidate antenna 55 pair meets MTPL specifications. Thus, at process block 744, the electronic device 10 enables TX diversity transmission using the combination of first antenna 55 and second antenna 55 to boost RACH signal strength relative to original assignment (e.g., based on using the first antenna 55 without TX diversity) to transmit the RACH signal. At process block 794, from the process blocks 792 or 796, the electronic device 10 performs other confirmation operations, transmits the RACH signal, and/or proceeds to communicate with the network 102 based on the antenna assignment from whichever of process block 744 or 746 the operation at process block 748 was preceded.

It is noted that when considering FIGS. 28-31, the electronic device 10 may perform similar MTPL testing operations based on test signals here as described above relative to process blocks 626, 628, 630, 632, 634 of FIG. 25 to determine the first MTPL, the second MTPL, and the third MTPL, or more MTPLs if additional antennas are being considered greater than two antennas. It is noted that when considering FIGS. 6-31, indications of MTPL for each communication scenario (e.g., SMSL, SMDL, SMSL with TX diversity, each respective combination of antenna 55 and power amplifier 66 pair, and the like) may be stored in memory 14 and referenced herein when determinations of MTPL are described. Thus, as an example, as opposed to testing for MTPL in FIG. 25, the electronic device 10 may sometimes access an indication of a corresponding MTPL.

Systems and methods described herein enable adjustments to open loop and closed loop MIMO communications and other communications (e.g., RACH signals) to enable higher transmit power levels to be used in communications between a user equipment and a network. Different examples are described herein that may be combined to provide various UE-confirmation points within communication initializing operations, at which the user equipment may confirm one or more selections of a network when generating a communication configuration for a communication channel. These systems and methods here describe operations that, when performed by the user equipment, may result in transmit signals sent with the maximum power levels implemented via RF circuitry of that user equipment. Some of the operations may be performed without network confirmation (e.g., without sending a UE-side selection indication to a base station) to drive changes in MTPL of transmit signals in less than an operation performed based on or with network confirmation. These and other technical effects may be described herein.

Indeed, various example systems and methods have been described herein. In one example system, an electronic device may include a transmitter having antennas and one or more processors coupled to the transmitter. The one or more processors may receive sensing data corresponding to a transmit power level of each antenna of the antennas, may cause the transmitter to send a sounding reference signal (SRS) set via one or more antennas to a network, where the one or more antennas may be selected from the antennas based on the sensing data, and may cause the transmitter to exchange user data with the network based on transmission diversity. Indeed, the one or more processors may determine the one or more antennas based on the sensing data corresponding to antenna pairs of the antennas and/or may identify the one or more antennas based on determining which antenna pair of the antennas has a largest combination of reference signal received power indications and transmit power levels. In some cases, the one or more processors may determine the one or more antennas based on the sensing data corresponding to respective power amplifier and antenna pairs of the antennas. In some cases, the transmit power level corresponds to a maximum transmission power difference. In some cases, the one or more processors may receive an indication of a data layer transmission mode from the network, confirm the data layer transmission mode based on the transmit power level of each antenna of the one or more antennas, and/or cause the transmitter to transmit the user data to the network based on the data layer transmission mode. The data layer transmission mode may correspond to a single data layer mode. The one or more processors may cause the transmitter to transmit the user data to the network based on transmission diversity and the single data layer mode. In some systems, the one or more processors may receive an indication of a data layer transmission mode from the network via a first antenna being coupled to a first power amplifier and may couple the first antenna to a second power amplifier, where a distance between the first antenna and the first power amplifier is greater than a distance between the first antenna and the second power amplifier.

In another example, a non-transitory computer-readable medium may include instructions that, when executed by one or more processors, cause the one or more processors to perform operations that include sending, via a transmitter coupled to one or more antennas, a sounding reference signal (SRS) set to a network. The operations may include receiving, via a receiver coupled to the one or more antennas, an indication of a data layer transmission mode from the network. The operations may include confirming the data layer transmission mode based on a power level of the one or more antennas. The operations may include sending, via the transmitter coupled to the one or more antennas, user data to the network using the data layer transmission mode. In some cases, the operations include receiving, via the receiver coupled to the one or more antennas, the indication of the data layer transmission mode and the indication of an antenna to be used with the data layer transmission mode from the network, confirming the antenna to be used with the data layer transmission mode based on the data layer transmission mode, and sending, via the transmitter coupled to the antenna, the user data to the network using the data layer transmission mode. In some cases, the operations include sending, via the transmitter coupled to the one or more antennas, the user data to the network using the data layer transmission mode and transmission diversity, where the data layer transmission mode may correspond to a single data layer. In some cases, the operations include receiving sensing data corresponding to a transmit power level of each antenna of antennas of the transmitter. The operations may include sending, via the transmitter coupled to the one or more antennas, the SRS set to the network, the one or more antennas selected from the antennas based on the sensing data. In some cases, the operations include receiving the power level of the one or more antennas from memory.

In yet another example, a method may include receiving, via a processor, sensing data corresponding to a transmit power level of each antenna of multiple antennas. The method may include sending, via a transmitter coupled to one or more antennas, a first sounding reference signal (SRS) set to a network, the one or more antennas selected from the multiple antennas based on the sensing data. The method may include receiving, via a receiver coupled to the one or more antennas, an indication of a data layer transmission mode from the network. The method may include sending, via the transmitter coupled to the one or more antennas, user data to the network using the data layer transmission mode. In some cases, the method includes sending, via the transmitter coupled to the one or more antennas, an indication to the network, the indication being able to change the data layer transmission mode that the network assigned. In some cases, the method includes selecting the one or more antennas from the antennas based on the sensing data and whether the network uses a dual data layer transmission mode as a dominant mode. In some cases, the method includes generating a control signal based on receiving the data layer transmission mode and an indication of voice-over-cellular operations, where the data layer transmission mode may correspond to a dual data layer transmission mode. The method may include modifying, via the transmitter coupled to the one or more antennas, the one or more antennas based on the control signal and sending, via the transmitter coupled to the one or more antennas being modified by the control signal, a second SRS set to the network, the second SRS set being able to switch the network to a single data layer transmission mode. In some cases, the method may include selecting the one or more antennas from the of antennas based on a distance between the one or more antennas and one or more power amplifiers. In some cases, the method includes sending, via the transmitter coupled to the one or more antennas, a Random Access Channel (RACH) transmission using transmission diversity.

In another example, a computing system may include a transceiver and one or more processors coupled to the transceiver. The one or more processors may cause the transceiver to receive a first indication from user equipment. The first indication may communicate a transmission power difference corresponding to one or more antennas of the user equipment. The one or more processors may program uplink (UL) resources associated with the user equipment using a spatial multiplexing single layer (SMSL) mode via a first data layer based on the first indication. The one or more processors may cause the transceiver to send, via the uplink resources, a second indication of the SMSL mode and the first data layer to the user equipment. In some systems, the transmission power difference corresponds to a maximum transmission power difference, and where the first data layer may correspond to an antenna of the one or more antennas. In some systems, the first indication corresponds to a first sounding reference signal (SRS) combination sent from the one or more antennas, where the first SRS combination indicates the transmission power difference through transmit power and uplink received signal strength. In some systems, the one or more processors may cause the transceiver to receive a second SRS combination and may determine to communicate with the user equipment according to a spatial multiplexing dual layer (SMDL) mode via the first data layer and a second data layer based on the second SRS combination. In some systems, the one or more processors may communicate with the user equipment using the SMDL mode based on the second SRS combination being different from the first SRS combination. In some systems, the first indication is associated with a power headroom report (PHR) indicative of the transmission power difference of the one or more antennas. In some systems, the first indication is associated with user equipment assistance information (UAI) indicative of the transmission power difference of the one or more antennas. In some systems, the one or more processors may generate the second indication as corresponding to a communication configuration including information identifying the SMSL mode, the first data layer, a paging cycle to be used with the first data layer, a time cycle to be used with the first data layer, a time cycle to be used with the second data layer, a center frequency indication, a preference among the first data layer and a second data layer, a voice-over-New Radio (VoNR) protocol indication, the SMSL mode as a dominant mode, or any combination thereof.

In yet another example, a user equipment device may include a transceiver having one or more antennas and one or more processors coupled to the transceiver. The one or more processors may cause the transceiver to transmit a first indication to a network, the first indication communicating a transmission power difference corresponding to the one or more antennas. The one or more processors may cause the transceiver to receive a second indication of a spatial multiplexing single layer (SMSL) mode via a first data layer from the network. The one or more processors may switch between the SMSL mode and a spatial multiplexing dual layer (SMDL) mode from the SMSL mode based on sensing data. In some systems, the one or more processors may change from the SMSL mode to the SMDL mode via the first data layer and a second data layer. In some systems, the one or more processors may generate a first sounding reference signal (SRS) combination, the first SRS combination indicating the transmission power difference through transmit power and received signal strength and may cause the transceiver to transmit the first indication to the network at least in part by causing each antenna of the one or more antennas to send a respective signal of the one or more signals. In some systems, the one or more processors may generate the first indication, the first indication associated with a power headroom report (PHR) indicative of the transmission power difference of the one or more antennas. In some systems, the one or more processors may generate the first indication, the first indication associated with user equipment assistance information (UAI) indicative of the transmission power difference of the one or more antennas. In some systems, the one or more processors may cause the network to change from the SMDL mode to the SMSL mode at least in part by muting a subset of the one or more antennas.

In another example, a method may include receiving, via a transceiver, a first indication from user equipment. The first indication may communicate a transmission power difference corresponding to one or more antennas of the user equipment. The method may include configuring, via a processor, uplink (UL) resources associated with the user equipment based on a spatial multiplexing single layer (SMSL) mode via a first data layer based on the first indication. The method may include sending, via the transceiver and the uplink (UL) resources, a second indication of the SMSL mode and the first data layer to the user equipment. In some systems and methods, the method may include receiving, via the transceiver, a first sounding reference signal (SRS) combination as the first indication from the user equipment. In some systems and methods, the method may include receiving, via the transceiver, a first sounding reference signal (SRS) combination as the first indication from the user equipment, where the first SRS combination may indicate the transmission power difference through transmit power and received signal strength. In some systems, the method may include receiving, via the transceiver, a second SRS combination from the user equipment, determining, via the processor, to communicate with the user equipment according to a spatial multiplexing dual layer (SMDL) mode via the first data layer and a second data layer based on the second SRS combination. In some systems, the method may include determining, via the processor, to communicate with the user equipment using the SMDL mode based on the second SRS combination being different from the first SRS combination. In some systems, the method may include generating, via the processor, the second indication, the second indication associated with a communication configuration including information identifying the SMSL mode, the first data layer, and a voice-over-New Radio (VoNR) protocol indication.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ,” it is intended that such elements are to be interpreted under 35 U.S.C. 112 (f). However, for any claims containing elements designated in any other manner, it is intended that such elements are not to be interpreted under 35 U.S.C. 112 (f).

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. An electronic device comprising:
a transmitter comprising a plurality of antennas; and
one or more processors coupled to the transmitter, the one or more processors configured to
receive sensing data corresponding to a transmit power level of each antenna of the plurality of antennas,
cause the transmitter to send a sounding reference signal (SRS) set via one or more antennas to a network, the one or more antennas selected from the plurality of antennas based on the sensing data, and
cause the transmitter to exchange user data with the network based on transmission diversity.

2. The electronic device of claim 1, wherein the one or more processors are configured to determine the one or more antennas based on the sensing data corresponding to antenna pairs of the plurality of antennas.

3. The electronic device of claim 2, wherein the one or more processors are configured to identify the one or more antennas based on determining which antenna pair of the plurality of antennas has a largest combination of reference signal received power indications and transmit power levels.

4. The electronic device of claim 1, wherein the one or more processors are configured to determine the one or more antennas based on the sensing data corresponding to respective power amplifier and antenna pairs of the plurality of antennas.

5. The electronic device of claim 1, wherein the transmit power level comprises a maximum transmission power difference.

6. The electronic device of claim 1, wherein the one or more processors are configured to
receive an indication of a data layer transmission mode from the network, and
confirm the data layer transmission mode based on the transmit power level of each antenna of the one or more antennas.

7. The electronic device of claim 6, wherein the one or more processors are configured to cause the transmitter to exchange the user data with the network based on the data layer transmission mode.

8. The electronic device of claim 7, wherein the data layer transmission mode corresponds to a single data layer mode, and wherein the one or more processors are configured to cause the transmitter to exchange the user data with the network based on transmission diversity and the single data layer mode.

9. The electronic device of claim 1, wherein the one or more processors are configured to
receive an indication of a data layer transmission mode from the network via a first antenna being coupled to a first power amplifier, and
couple the first antenna to a second power amplifier, wherein a distance between the first antenna and the first power amplifier is greater than a distance between the first antenna and the second power amplifier.

10. A non-transitory computer-readable medium comprising instructions that, when executed by one or more processors, cause the one or more processors to perform operations comprising:
sending, via a transmitter coupled to one or more antennas, a sounding reference signal (SRS) set to a network;
receiving, via a receiver coupled to the one or more antennas, an indication of a data layer transmission mode from the network;
confirming the data layer transmission mode based on a power level of the one or more antennas; and
sending, via the transmitter coupled to the one or more antennas, user data to the network using the data layer transmission mode.

11. The non-transitory computer-readable medium of claim 10, wherein the operations comprise:
receiving, via the receiver coupled to the one or more antennas, the indication of the data layer transmission mode and the indication of an antenna to be used with the data layer transmission mode from the network;
confirming the antenna to be used with the data layer transmission mode based on the data layer transmission mode; and
sending, via the transmitter coupled to the antenna, user data to the network using the data layer transmission mode.

12. The non-transitory computer-readable medium of claim 10, wherein the operations comprise sending, via the transmitter coupled to the one or more antennas, user data to the network using the data layer transmission mode and transmission diversity, and wherein the data layer transmission mode corresponds to a single data layer.

13. The non-transitory computer-readable medium of claim 10, wherein the operations comprise
receiving sensing data corresponding to a transmit power level of each antenna of a plurality of antennas of the transmitter, and
sending, via the transmitter coupled to the one or more antennas, the SRS set to the network, the one or more antennas selected from the plurality of antennas based on the sensing data.

14. The non-transitory computer-readable medium of claim 10, wherein the operations comprise receiving the power level of the one or more antennas from memory.

15. A method, comprising:
receiving, via a processor, sensing data corresponding to a transmit power level of each antenna of a plurality of antennas;
sending, via a transmitter coupled to one or more antennas, a first sounding reference signal (SRS) set to a network, the one or more antennas selected from the plurality of antennas based on the sensing data;
receiving, via a receiver coupled to the one or more antennas, an indication of a data layer transmission mode from the network; and
sending, via the transmitter coupled to the one or more antennas, user data to the network using the data layer transmission mode.

16. The method of claim 15, comprising:
sending, via the transmitter coupled to the one or more antennas, an indication to the network, the indication being configured to change the data layer transmission mode that the network assigned.

17. The method of claim 15, comprising selecting the one or more antennas from the plurality of antennas based on the sensing data and whether the network uses a dual data layer transmission mode as a dominant mode.

18. The method of claim 15, comprising:
generating a control signal based on receiving the data layer transmission mode and an indication of voice-over-cellular operations, the data layer transmission mode corresponding to a dual data layer transmission mode;
modifying, via the transmitter coupled to the one or more antennas, the one or more antennas based on the control signal; and
sending, via the transmitter coupled to the one or more antennas being modified by the control signal, a second SRS set to the network, the second SRS set being configured to switch the network to a single data layer transmission mode.

19. The method of claim 15, comprising selecting the one or more antennas from the plurality of antennas based on a distance between the one or more antennas and one or more power amplifiers.

20. The method of claim 15, comprising sending, via the transmitter coupled to the one or more antennas, a Random Access Channel (RACH) transmission using transmission diversity.
